(19) United States
(12) Patent Application Publication
(10) Pub. No.: US 2026/0323094 A1
(43) Pub. Date: Oct. 15, 2026

(54) INFERRED DISPLAY ORDER HINT FOR SHOW FRAMES

(71) Applicant: GOOGLE LLC, Mountain View, CA (US)

(72) Inventors: Cheng Chen, Milpitas, CA (US); Jingning Han, Santa Clara, CA (US)

(21) Appl. No.: 19/485,418

(22) PCT Filed: May 14, 2024
(86) PCT No.: PCT/US2024/029194

§ 371 Date: Nov. 18, 2025

Related U.S. Application Data
(60) Provisional application No. 63/467,740, filed on May 19, 2023.

(51) Int. Cl. H04N 19/70

(52) U.S. Cl. CPC H04N 19/70

(57) ABSTRACT

Decoding using inferred display order hint for show frames includes obtaining reconstructed frame data by accessing a show frame value from a frame header for the current frame, obtaining a current display order hint value by, in response to determining that the show frame value is a first defined show frame value, incrementing the current display order hint value, obtaining a display order hint value for the current frame by, in response to determining that the show frame value is the first defined show frame value, obtaining, as the display order hint value for the current frame, the current display order hint value, wherein an order hint value for the current frame is absent from the encoded bitstream, and including the reconstructed frame data in the reconstructed video data in accordance with the display order hint value for the current frame.

### CROSS-REFERENCE TO RELATED APPLICATION(S)

This application claims priority to and the benefit of U.S. Provisional Application Patent Ser. No. 63/467,740, filed May 19, 2023, the entire disclosure of which is hereby incorporated by reference.

### BACKGROUND

Digital images and video can be used, for example, on the internet, for remote business meetings via video conferencing, high-definition video entertainment, video advertisements, or sharing of user-generated content. Due to the large amount of data involved in transferring and processing image and video data, high-performance compression may be advantageous for transmission and storage. Accordingly, it would be advantageous to provide high-resolution image and video transmitted over communications channels having limited bandwidth.

### SUMMARY

This application relates to encoding and decoding of image data, video stream data, or both for transmission, storage, or both. Disclosed herein are aspects of systems, methods, and apparatuses for encoding and decoding using inferred display order hint for show frames.

Variations in these and other aspects will be described in additional detail hereafter.

An aspect is a method for encoding using inferred display order hint for show frames. Encoding using inferred display order hint for show frames includes obtaining an encoded bitstream. Obtaining the encoded bitstream includes obtaining input video data including a sequence of frames, obtaining a frame from the sequence of frames, obtaining a target display order value for the frame, obtaining a show frame value for the frame, including the show frame value in a frame header for the frame, in response to determining that the show frame value is a first defined show frame value, omitting including the target display order value in the frame header, and including the frame header in the encoded bitstream. Encoding using inferred display order hint for show frames includes outputting the encoded bitstream.

An aspect is apparatus for encoding using inferred display order hint for show frames. The apparatus includes a non-transitory computer readable medium and a processor configured to execute instructions stored on the non-transitory computer readable medium to perform encoding using inferred display order hint for show frames. To perform encoding using inferred display order hint for show frames, the processor is configured to execute the instructions to obtain an encoded bitstream. To obtain the encoded bitstream the processor is configured to execute the instructions to obtain input video data including a sequence of frames, obtain a frame from the sequence of frames, obtain a target display order value for the frame, obtain a show frame value for the frame, include the show frame value in a frame header for the frame, in response to a determination that the show frame value is a first defined show frame value, omit including the target display order value in the frame header, and include the frame header in the encoded bitstream. To perform encoding using inferred display order hint for show frames, the processor is configured to execute the instructions to output the encoded bitstream.

An aspect is a method for decoding using inferred display order hint for show frames. Decoding using inferred display order hint for show frames includes generating reconstructed video data by decoding an encoded bitstream. Decoding the encoded bitstream includes obtaining reconstructed frame data for a current frame of a sequence of frames. Obtaining the reconstructed frame data includes accessing, from the encoded bitstream, a show frame value from a frame header for the current frame, obtaining a current display order hint value, wherein obtaining the current display order hint value includes, in response to determining that the show frame value is a first defined show frame value, incrementing the current display order hint value, obtaining a display order hint value for the current frame, wherein obtaining the display order hint value for the current frame includes, in response to determining that the show frame value is the first defined show frame value, obtaining, as the display order hint value for the current frame, the current display order hint value, wherein an order hint value for the current frame is absent from the encoded bitstream, and including the reconstructed frame data in the reconstructed video data in accordance with the display order hint value for the current frame. Decoding using inferred display order hint for show frames includes outputting the reconstructed video data.

An aspect is apparatus for encoding using inferred display order hint for show frames. The apparatus includes a non-transitory computer readable medium and a processor configured to execute instructions stored on the non-transitory computer readable medium to perform encoding using inferred display order hint for show frames. To perform encoding using inferred display order hint for show frames, the processor is configured to execute the instructions to generate reconstructed video data. To generate the reconstructed video data the processor is configured to execute the instructions to decode an encoded bitstream. To decode the encoded bitstream the processor is configured to execute the instructions to obtain reconstructed frame data for a current frame of a sequence of frames. To obtain the reconstructed frame data the processor is configured to execute the instructions to access, from the encoded bitstream, a show frame value from a frame header for the current frame, obtain a current display order hint value, wherein to obtain the current display order hint value the processor is configured to execute the instructions to in response to a determination that the show frame value is a first defined show frame value, increment the current display order hint value, obtain a display order hint value for the current frame, wherein to obtain the display order hint value for the current frame the processor is configured to execute the instructions to, in response to a determination that the show frame value is the first defined show frame value, obtain, as the display order hint value for the current frame, the current display order hint value, wherein an order hint value for the current frame is absent from the encoded bitstream, and include the reconstructed frame data in the reconstructed video data in accordance with the display order hint value for the current frame. To perform encoding using inferred display order hint for show frames, the processor is configured to execute the instructions to output the reconstructed video data.

An aspect is non-transitory computer-readable storage medium having stored thereon an encoded bitstream comprising a first frame header for a first frame of a sequence of frames and a second frame header for a second frame of the sequence of frames. The first frame header includes a first show frame value for the first frame that has a first defined show frame value, and an order hint value for the first frame is absent from the encoded bitstream. The second frame header includes a second show frame value for the second frame that has a second defined show frame value and a second order hint value for the second frame.

### BRIEF DESCRIPTION OF THE DRAWINGS

The description herein makes reference to the accompanying drawings wherein like reference numerals refer to like parts throughout the several views unless otherwise noted or otherwise clear from context.

FIG. 1 is a diagram of a computing device in accordance with implementations of this disclosure.

FIG. 2 is a diagram of a computing and communications system in accordance with implementations of this disclosure.

FIG. 3 is a diagram of a video stream for use in encoding and decoding in accordance with implementations of this disclosure.

FIG. 4 is a block diagram of an encoder in accordance with implementations of this disclosure.

FIG. 5 is a block diagram of a decoder in accordance with implementations of this disclosure.

FIG. 6 is a block diagram of a representation of a portion of a frame in accordance with implementations of this disclosure.

FIG. 7 is a block diagram of an example of encoding using inferred display order hint for show frames in accordance with implementations of this disclosure.

FIG. 8 is a flowchart diagram of an example of decoding using inferred display order hint for show frames in accordance with implementations of this disclosure.

FIG. 9 is a flowchart diagram of an example of obtaining a current display order hint value in accordance with implementations of this disclosure.

FIG. 10 is a flowchart diagram of an example of obtaining a display order hint value for a current frame in accordance with implementations of this disclosure.

FIG. 11 shows a block diagram of an example of coding using inferred display order hint for show frames for a sequence of frame in accordance with implementations of this disclosure.

### DETAILED DESCRIPTION

Image and video compression schemes may include breaking an image, or frame, into smaller portions, such as blocks, and generating an output bitstream using techniques to minimize the bandwidth utilization of the information included for each block in the output. In some implementations, the information included for each block in the output may be limited by reducing spatial redundancy, reducing temporal redundancy, or a combination thereof. For example, temporal or spatial redundancies may be reduced by predicting a frame, or a portion thereof, based on information available to both the encoder and decoder, and including information representing a difference, or residual, between the predicted frame and the original frame in the encoded bitstream. The residual information may be further compressed by transforming the residual information into transform coefficients (e.g., energy compaction), quantizing the transform coefficients, and entropy coding the quantized transform coefficients. Other coding information, such as motion information, may be included in the encoded bitstream, which may include transmitting differential information based on predictions of the encoding information, which may be entropy coded to further reduce the corresponding bandwidth utilization. An encoded bitstream can be decoded to reconstruct the blocks and the source images from the limited information. In some implementations, the accuracy, efficiency, or both, of coding a block using either inter-prediction or intra-prediction may be limited.

Some block-based hybrid video coding techniques, or codecs, to improve coding efficiency, encode one or more frames of a sequence of frames in an order, in the encoded bitstream, that differs from the input order or target display order for the sequence of frames. Some frames, such as frames included in the encoded bitstream in a position that differs from the input, or target display order, position of the frame may be encoded with a first value of a show frame flag that indicates buffering of the decoded frame without immediately displaying the decoded frame. Some frames, such as frames included in the encoded bitstream in a position that matches the input, or target display order, position of the frame may be encoded with a second value of the show frame flag that indicates immediately displaying the decoded frame. To avoid decreased decoding accuracy, the encoder includes order hint data in a header for a respective frame indicating a target display order for the respective frame.

The encoding and decoding including motion refinement using inferred display order hint for show frames described herein improves on video coding techniques, or codecs, that signal a display order hint for frames that include the second value of the show frame flag by omitting, or excluding, from the encoded bitstream, the display order hint for frames that include the second value of the show frame flag, wherein the decoder determines, or infers, the display order for the respective frame using other data. For example, encoding and decoding including motion refinement using inferred display order hint for show frames as described herein may reduce bandwidth utilization by up to eight bits per frame that include the second value of the show frame flag without increased complexity.

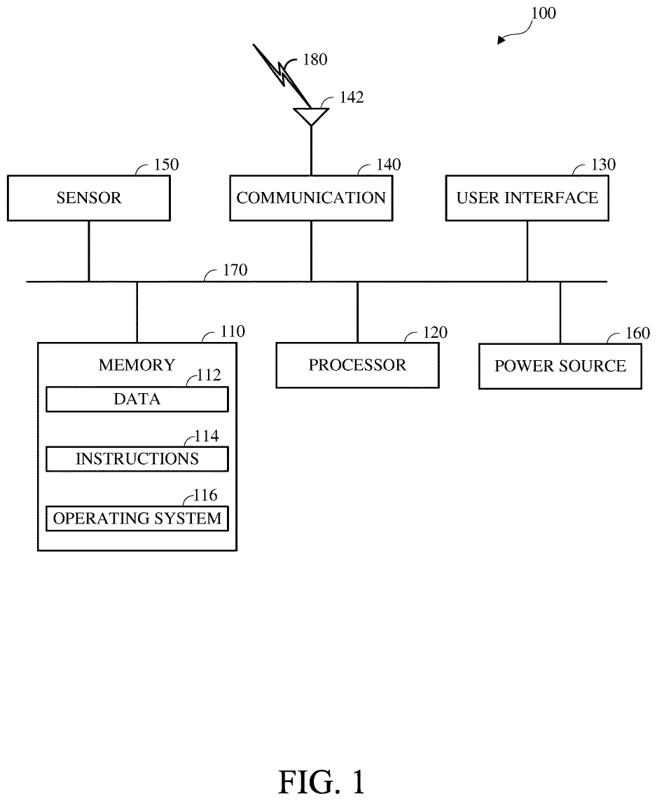

FIG. 1 is a diagram of a computing device 100 in accordance with implementations of this disclosure. The computing device 100 shown includes a memory 110, a processor 120, a user interface (UI) 130, an electronic communication unit 140, a sensor 150, a power source 160, and a bus 170. As used herein, the term “computing device” includes any unit, or a combination of units, capable of performing any method, or any portion or portions thereof, disclosed herein.

The computing device 100 may be a stationary computing device, such as a personal computer (PC), a server, a workstation, a minicomputer, or a mainframe computer; or a mobile computing device, such as a mobile telephone, a personal digital assistant (PDA), a laptop, or a tablet PC. Although shown as a single unit, any one element or elements of the computing device 100 can be integrated into any number of separate physical units. For example, the user interface 130 and processor 120 can be integrated in a first physical unit and the memory 110 can be integrated in a second physical unit.

The memory 110 can include any non-transitory computer-usable or computer-readable medium, such as any tangible device that can, for example, contain, store, communicate, or transport data 112, instructions 114, an operating system 116, or any information associated therewith, for use by or in connection with other components of the computing device 100. The non-transitory computer-usable or computer-readable medium can be, for example, a solid-state drive, a memory card, removable media, a read-only memory (ROM), a random-access memory (RAM), any type of disk including a hard disk, a floppy disk, an optical disk, a magnetic or optical card, an application-specific integrated circuits (ASICs), or any type of non-transitory media suitable for storing electronic information, or any combination thereof.

Although shown a single unit, the memory 110 may include multiple physical units, such as one or more primary memory units, such as random-access memory units, one or more secondary data storage units, such as disks, or a combination thereof. For example, the data 112, or a portion thereof, the instructions 114, or a portion thereof, or both, may be stored in a secondary storage unit and may be loaded or otherwise transferred to a primary storage unit in conjunction with processing the respective data 112, executing the respective instructions 114, or both. In some implementations, the memory 110, or a portion thereof, may be removable memory.

The data 112 can include information, such as input audio data, encoded audio data, decoded audio data, or the like. The instructions 114 can include directions, such as code, for performing any method, or any portion or portions thereof, disclosed herein. The instructions 114 can be realized in hardware, software, or any combination thereof. For example, the instructions 114 may be implemented as information stored in the memory 110, such as a computer program, which may be executed by the processor 120 to perform any of the respective methods, algorithms, aspects, or combinations thereof, as described herein.

Although shown as included in the memory 110, in some implementations, the instructions 114, or a portion thereof, may be implemented as a special purpose processor, or circuitry, that can include specialized hardware for carrying out any of the methods, algorithms, aspects, or combinations thereof, as described herein. Portions of the instructions 114 can be distributed across multiple processors on the same machine or different machines or across a network such as a local area network, a wide area network, the Internet, or a combination thereof.

The processor 120 can include any device or system capable of manipulating or processing a digital signal or other electronic information now-existing or hereafter developed, including optical processors, quantum processors, molecular processors, or a combination thereof. For example, the processor 120 can include a special purpose processor, a central processing unit (CPU), a digital signal processor (DSP), a plurality of microprocessors, one or more microprocessor in association with a DSP core, a controller, a microcontroller, an Application Specific Integrated Circuit (ASIC), a Field Programmable Gate Array (FPGA), a programmable logic array, programmable logic controller, microcode, firmware, any type of integrated circuit (IC), a state machine, or any combination thereof. As used herein, the term “processor” includes a single processor or multiple processors.

The user interface 130 can include any unit capable of interfacing with a user, such as a virtual or physical keypad, a touchpad, a display, a touch display, a speaker, a microphone, a video camera, a sensor, or any combination thereof. For example, the user interface 130 may be an audio-visual display device, and the computing device 100 may present audio, such as decoded audio, using the user interface 130 audio-visual display device, such as in conjunction with displaying video, such as decoded video. Although shown as a single unit, the user interface 130 may include one or more physical units. For example, the user interface 130 may include an audio interface for performing audio communication with a user, and a touch display for performing visual and touch-based communication with the user.

The electronic communication unit 140 can transmit, receive, or transmit and receive signals via a wired or wireless electronic communication medium 180, such as a radio frequency (RF) communication medium, an ultraviolet (UV) communication medium, a visible light communication medium, a fiber optic communication medium, a wireline communication medium, or a combination thereof. For example, as shown, the electronic communication unit 140 is operatively connected to an electronic communication interface 142, such as an antenna, configured to communicate via wireless signals.

Although the electronic communication interface 142 is shown as a wireless antenna in FIG. 1, the electronic communication interface 142 can be a wireless antenna, as shown, a wired communication port, such as an Ethernet port, an infrared port, a serial port, or any other wired or wireless unit capable of interfacing with a wired or wireless electronic communication medium 180. Although FIG. 1 shows a single electronic communication unit 140 and a single electronic communication interface 142, any number of electronic communication units and any number of electronic communication interfaces can be used.

The sensor 150 may include, for example, an audio-sensing device, a visible light-sensing device, a motion sensing device, or a combination thereof. For example, 100 the sensor 150 may include a sound-sensing device, such as a microphone, or any other sound-sensing device now existing or hereafter developed that can sense sounds in the proximity of the computing device 100, such as speech or other utterances, made by a user operating the computing device 100. In another example, the sensor 150 may include a camera, or any other image-sensing device now existing or hereafter developed that can sense an image such as the image of a user operating the computing device. Although a single sensor 150 is shown, the computing device 100 may include a number of sensors 150. For example, the computing device 100 may include a first camera oriented with a field of view directed toward a user of the computing device 100 and a second camera oriented with a field of view directed away from the user of the computing device 100.

The power source 160 can be any suitable device for powering the computing device 100. For example, the power source 160 can include a wired external power source interface; one or more dry cell batteries, such as nickel-cadmium (NiCd), nickel-zinc (NiZn), nickel metal hydride (NiMH), lithium-ion (Li-ion); solar cells; fuel cells; or any other device capable of powering the computing device 100. Although a single power source 160 is shown in FIG. 1, the computing device 100 may include multiple power sources 160, such as a battery and a wired external power source interface.

Although shown as separate units, the electronic communication unit 140, the electronic communication interface 142, the user interface 130, the power source 160, or portions thereof, may be configured as a combined unit. For example, the electronic communication unit 140, the electronic communication interface 142, the user interface 130, and the power source 160 may be implemented as a communications port capable of interfacing with an external display device, providing communications, power, or both.

One or more of the memory 110, the processor 120, the user interface 130, the electronic communication unit 140, the sensor 150, or the power source 160, may be operatively coupled via a bus 170. Although a single bus 170 is shown in FIG. 1, a computing device 100 may include multiple buses. For example, the memory 110, the processor 120, the user interface 130, the electronic communication unit 140, the sensor 150, and the bus 170 may receive power from the power source 160 via the bus 170. In another example, the memory 110, the processor 120, the user interface 130, the electronic communication unit 140, the sensor 150, the power source 160, or a combination thereof, may communicate data, such as by sending and receiving electronic signals, via the bus 170.

Although not shown separately in FIG. 1, one or more of the processor 120, the user interface 130, the electronic communication unit 140, the sensor 150, or the power source 160 may include internal memory, such as an internal buffer or register. For example, the processor 120 may include internal memory (not shown) and may read data 112 from the memory 110 into the internal memory (not shown) for processing.

Although shown as separate elements, the memory 110, the processor 120, the user interface 130, the electronic communication unit 140, the sensor 150, the power source 160, and the bus 170, or any combination thereof can be integrated in one or more electronic units, circuits, or chips.

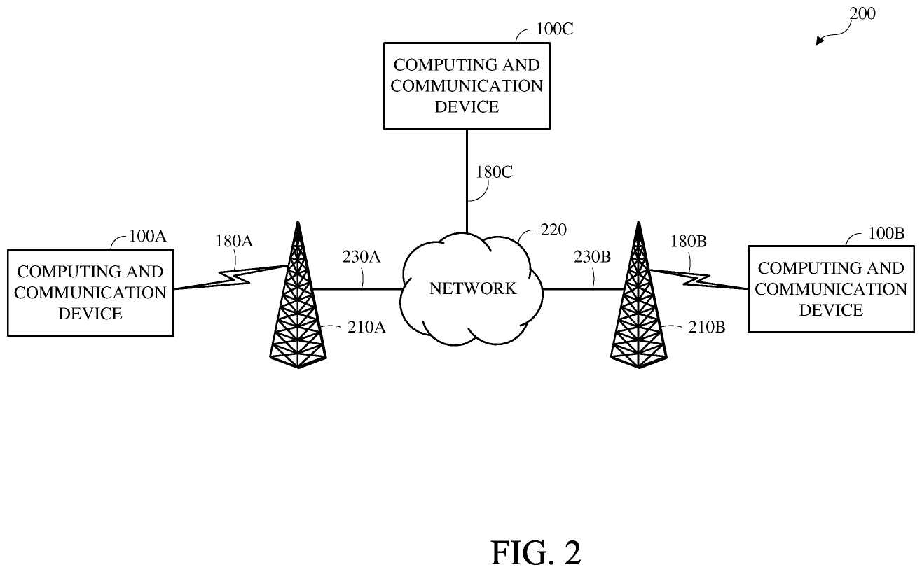

FIG. 2 is a diagram of a computing and communications system 200 in accordance with implementations of this disclosure. The computing and communications system 200 shown includes computing and communication devices 100A, 100B, 100C, access points 210A, 210B, and a network 220. For example, the computing and communication system 200 can be a multiple access system that provides communication, such as voice, audio, data, video, messaging, broadcast, or a combination thereof, to one or more wired or wireless communicating devices, such as the computing and communication devices 100A, 100B, 100C. Although, for simplicity, FIG. 2 shows three computing and communication devices 100A, 100B, 100C, two access points 210A, 210B, and one network 220, any number of computing and communication devices, access points, and networks can be used.

A computing and communication device 100A, 100B, 100C can be, for example, a computing device, such as the computing device 100 shown in FIG. 1. For example, the computing and communication devices 100A, 100B may be user devices, such as a mobile computing device, a laptop, a thin client, or a smartphone, and the computing and communication device 100C may be a server, such as a mainframe or a cluster. Although the computing and communication device 100A and the computing and communication device 100B are described as user devices, and the computing and communication device 100C is described as a server, any computing and communication device may perform some or all of the functions of a server, some, or all, of the functions of a user device, or some or all of the functions of a server and a user device. For example, the server computing and communication device 100C may receive, encode, process, store, transmit, or a combination thereof audio data and one or both of the computing and communication device 100A and the computing and communication device 100B may receive, decode, process, store, present, or a combination thereof the audio data.

Each computing and communication device 100A, 100B, 100C, which may include a user equipment (UE), a mobile station, a fixed or mobile subscriber unit, a cellular telephone, a personal computer, a tablet computer, a server, consumer electronics, or any similar device, can be configured to perform wired or wireless communication, such as via the network 220. For example, the computing and communication devices 100A, 100B, 100C can be configured to transmit or receive wired or wireless communication signals. Although each computing and communication device 100A, 100B, 100C is shown as a single unit, a computing and communication device can include any number of interconnected elements.

Each access point 210A, 210B can be any type of device configured to communicate with a computing and communication device 100A, 100B, 100C, a network 220, or both via wired or wireless communication links 180A, 180B, 180C. For example, an access point 210A, 210B can include a base station, a base transceiver station (BTS), a Node-B, an enhanced Node-B (eNode-B), a Home Node-B (HNode-B), a wireless router, a wired router, a hub, a relay, a switch, or any similar wired or wireless device. Although each access point 210A, 210B is shown as a single unit, an access point can include any number of interconnected elements.

The network 220 can be any type of network configured to provide services, such as voice, data, applications, voice over internet protocol (VOIP), or any other communications protocol or combination of communications protocols, over a wired or wireless communication link. For example, the network 220 can be a local area network (LAN), wide area network (WAN), virtual private network (VPN), a mobile or cellular telephone network, the Internet, or any other means of electronic communication. The network can use a communication protocol, such as the transmission control protocol (TCP), the user datagram protocol (UDP), the internet protocol (IP), the real-time transport protocol (RTP) the HyperText Transport Protocol (HTTP), or a combination thereof.

The computing and communication devices 100A, 100B, 100C can communicate with each other via the network 220 using one or more a wired or wireless communication links, or via a combination of wired and wireless communication links. For example, as shown the computing and communication devices 100A, 100B can communicate via wireless communication links 180A, 180B, and computing and communication device 100C can communicate via a wired communication link 180C. Any of the computing and communication devices 100A, 100B, 100C may communicate using any wired or wireless communication link, or links. For example, a first computing and communication device 100A can communicate via a first access point 210A using a first type of communication link, a second computing and communication device 100B can communicate via a second access point 210B using a second type of communication link, and a third computing and communication device 100C can communicate via a third access point (not shown) using a third type of communication link. Similarly, the access points 210A, 210B can communicate with the network 220 via one or more types of wired or wireless communication links 230A, 230B. Although FIG. 2 shows the computing and communication devices 100A, 100B, 100C in communication via the network 220, the computing and communication devices 100A, 100B, 100C can communicate with each other via any number of communication links, such as a direct wired or wireless communication link.

In some implementations, communications between one or more of the computing and communication device 100A, 100B, 100C may omit communicating via the network 220 and may include transferring data via another medium (not shown), such as a data storage device. For example, the server computing and communication device 100C may store audio data, such as encoded audio data, in a data storage device, such as a portable data storage unit, and one or both of the computing and communication device 100A or the computing and communication device 100B may access, read, or retrieve the stored audio data from the data storage unit, such as by physically disconnecting the data storage device from the server computing and communication device 100C and physically connecting the data storage device to the computing and communication device 100A or the computing and communication device 100B.

Other implementations of the computing and communications system 200 are possible. For example, in an implementation, the network 220 can be an ad-hoc network and can omit one or more of the access points 210A, 210B. The computing and communications system 200 may include devices, units, or elements not shown in FIG. 2. For example, the computing and communications system 200 may include many more communicating devices, networks, and access points.

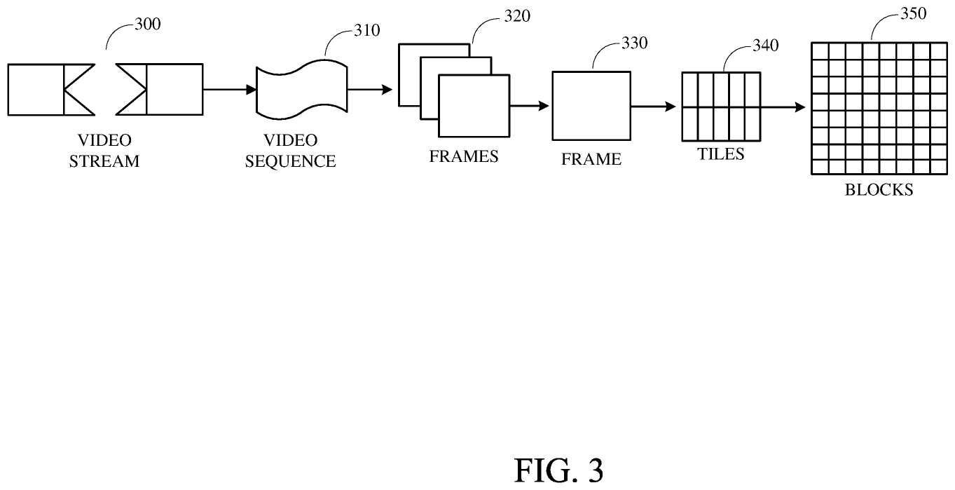

FIG. 3 is a diagram of a video stream 300 for use in encoding and decoding in accordance with implementations of this disclosure. A video stream 300, such as a video stream captured by a video camera or a video stream generated by a computing device, may include a video sequence 310. The video sequence 310 may include a sequence of adjacent frames 320. Although three adjacent frames 320 are shown, the video sequence 310 can include any number of adjacent frames 320.

Each frame 330 from the adjacent frames 320 may represent a single image from the video stream. Although not shown in FIG. 3, a frame 330 may include one or more segments, tiles, or planes, which may be coded, or otherwise processed, independently, such as in parallel. A frame 330 may include one or more tiles 340. Each of the tiles 340 may be a rectangular region of the frame that can be coded independently. Each of the tiles 340 may include respective blocks 350. Although not shown in FIG. 3, a block can include pixels. For example, a block can include a 16×16 group of pixels, an 8×8 group of pixels, an 8×16 group of pixels, or any other group of pixels. Unless otherwise indicated herein, the term ‘block’ can include a superblock, a macroblock, a segment, a slice, or any other portion of a frame. A frame, a block, a pixel, or a combination thereof can include display information, such as luminance information, chrominance information, or any other information that can be used to store, modify, communicate, or display the video stream or a portion thereof.

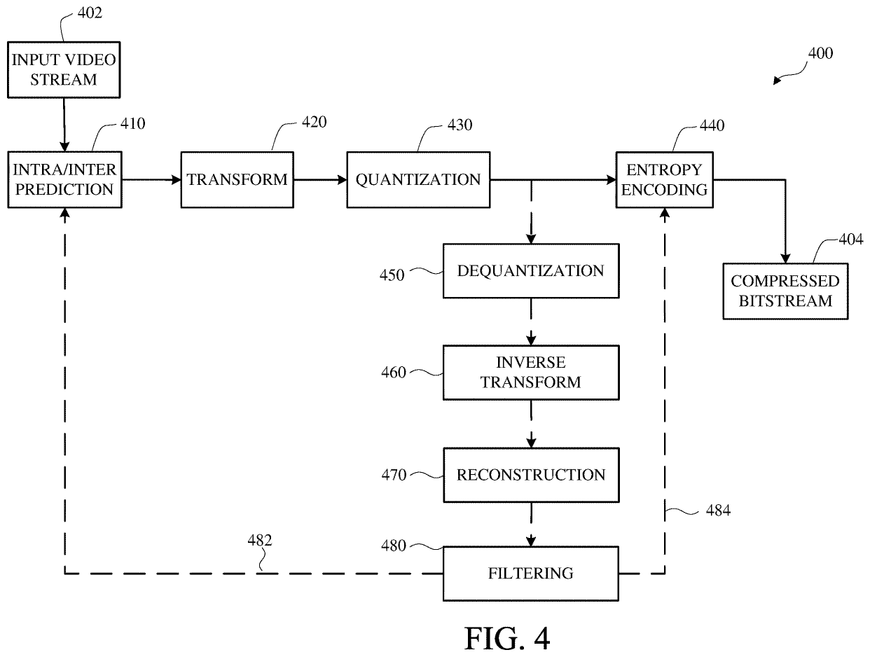

FIG. 4 is a block diagram of an encoder 400 in accordance with implementations of this disclosure. Encoder 400 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to encode video data as described herein. The encoder 400 can be implemented as specialized hardware included, for example, in computing device 100.

The encoder 400 can encode an input video stream 402, such as the video stream 300 shown in FIG. 3, to generate an encoded (compressed) bitstream 404. In some implementations, the encoder 400 may include a forward path for generating the compressed bitstream 404. The forward path may include an intra/inter prediction unit 410, a transform unit 420, a quantization unit 430, an entropy encoding unit 440, or any combination thereof. In some implementations, the encoder 400 may include a reconstruction path (indicated by the broken connection lines) to reconstruct a frame for encoding of further blocks. The reconstruction path may include a dequantization unit 450, an inverse transform unit 460, a reconstruction unit 470, a filtering unit 480, or any combination thereof. Other structural variations of the encoder 400 can be used to encode the video stream 402.

For encoding the video stream 402, each frame within the video stream 402 can be processed in units of blocks. Thus, a current block may be identified from the blocks in a frame, and the current block may be encoded.

At the intra/inter prediction unit 410, the current block can be encoded using either intra-frame prediction, which may be within a single frame, or inter-frame prediction, which may be from frame to frame. Intra-prediction may include generating a prediction block from samples in the current frame that have been previously encoded and reconstructed. Inter-prediction may include generating a prediction block from samples in one or more previously constructed reference frames. Generating a prediction block for a current block in a current frame may include performing motion estimation to generate a motion vector indicating an appropriate reference portion of the reference frame.

The intra/inter prediction unit 410 may subtract the prediction block from the current block (raw block) to produce a residual block. The transform unit 420 may perform a block-based transform, which may include transforming the residual block into transform coefficients in, for example, the frequency domain. Examples of block-based transforms include the Karhunen-Loeve Transform (KLT), the Discrete Cosine Transform (DCT), the Singular Value Decomposition Transform (SVD), and the Asymmetric Discrete Sine Transform (ADST). In an example, the DCT may include transforming a block into the frequency domain. The DCT may include using transform coefficient values based on spatial frequency, with the lowest frequency (i.e., DC) coefficient at the top-left of the matrix and the highest frequency coefficient at the bottom-right of the matrix.

The quantization unit 430 may convert the transform coefficients into discrete quantum values, which may be referred to as quantized transform coefficients or quantization levels. The quantized transform coefficients can be entropy encoded by the entropy encoding unit 440 to produce entropy-encoded coefficients. Entropy encoding can include using a probability distribution metric. The entropy-encoded coefficients and information used to decode the block, which may include the type of prediction used, motion vectors, and quantizer values, can be output to the compressed bitstream 404. The compressed bitstream 404 can be formatted using various techniques, such as run-length encoding (RLE) and zero-run coding.

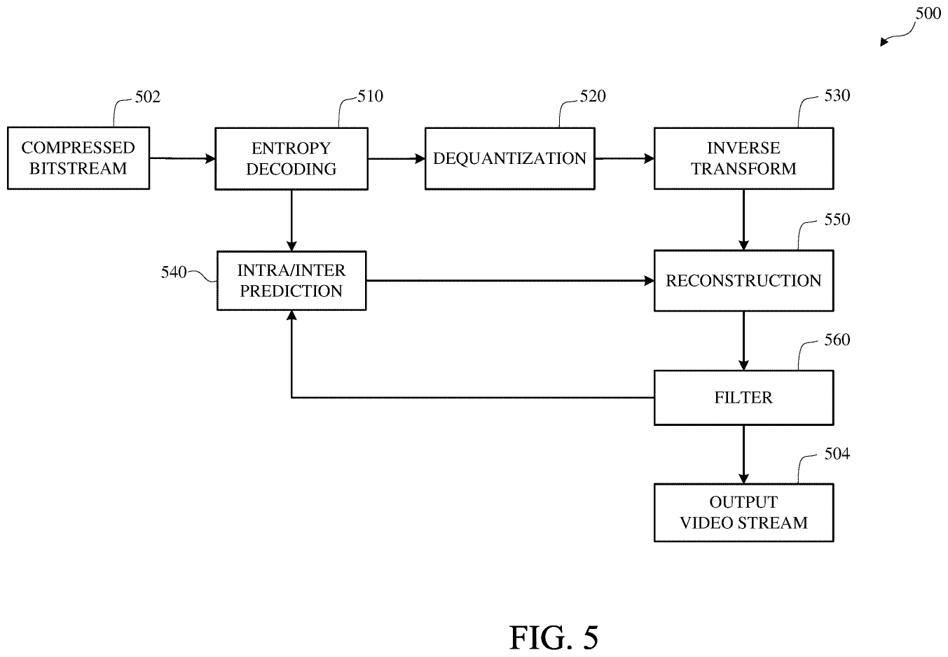

The reconstruction path can be used to maintain reference frame synchronization between the encoder 400 and a corresponding decoder, such as the decoder 500 shown in FIG. 5. The reconstruction path may be similar to the decoding process discussed below and may include decoding the encoded frame, or a portion thereof, which may include decoding an encoded block, which may include dequantizing the quantized transform coefficients at the dequantization unit 450 and inverse transforming the dequantized transform coefficients at the inverse transform unit 460 to produce a derivative residual block. The reconstruction unit 470 may add the prediction block generated by the intra/inter prediction unit 410 to the derivative residual block to create a decoded block. The filtering unit 480 can be applied to the decoded block to generate a reconstructed block, which may reduce distortion, such as blocking artifacts. Although one filtering unit 480 is shown in FIG. 4, filtering the decoded block may include loop filtering, deblocking filtering, or other types of filtering or combinations of types of filtering. The reconstructed block may be stored or otherwise made accessible as a reconstructed block, which may be a portion of a reference frame, for encoding another portion of the current frame, another frame, or both, as indicated by the broken line at 482. Coding information, such as deblocking threshold index values, for the frame may be encoded, included in the compressed bitstream 404, or both, as indicated by the broken line at 484.

Other variations of the encoder 400 can be used to encode the compressed bitstream 404. For example, a non-transform-based encoder 400 can quantize the residual block directly without the transform unit 420. In some implementations, the quantization unit 430 and the dequantization unit 450 may be combined into a single unit.

FIG. 5 is a block diagram of a decoder 500 in accordance with implementations of this disclosure. The decoder 500 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to decode video data as described herein. The decoder 500 can be implemented as specialized hardware included, for example, in computing device 100.

The decoder 500 may receive a compressed bitstream 502, such as the compressed bitstream 404 shown in FIG. 4, and may decode the compressed bitstream 502 to generate an output video stream 504. The decoder 500 may include an entropy decoding unit 510, a dequantization unit 520, an inverse transform unit 530, an intra/inter prediction unit 540, a reconstruction unit 550, a filtering unit 560, or any combination thereof. Other structural variations of the decoder 500 can be used to decode the compressed bitstream 502.

The entropy decoding unit 510 may decode data elements within the compressed bitstream 502 using, for example, Context Adaptive Binary Arithmetic Decoding, to produce a set of quantized transform coefficients. The dequantization unit 520 can dequantize the quantized transform coefficients, and the inverse transform unit 530 can inverse transform the dequantized transform coefficients to produce a derivative residual block, which may correspond to the derivative residual block generated by the inverse transform unit 460 shown in FIG. 4. Using header information decoded from the compressed bitstream 502, the intra/inter prediction unit 540 may generate a prediction block corresponding to the prediction block created in the encoder 400. At the reconstruction unit 550, the prediction block can be added to the derivative residual block to create a decoded block. The filtering unit 560 can be applied to the decoded block to reduce artifacts, such as blocking artifacts, which may include loop filtering, deblocking filtering, or other types of filtering or combinations of types of filtering, and which may include generating a reconstructed block, which may be output as the output video stream 504.

Other variations of the decoder 500 can be used to decode the compressed bitstream 502. For example, the decoder 500 can produce the output video stream 504 without the deblocking filtering unit 560.

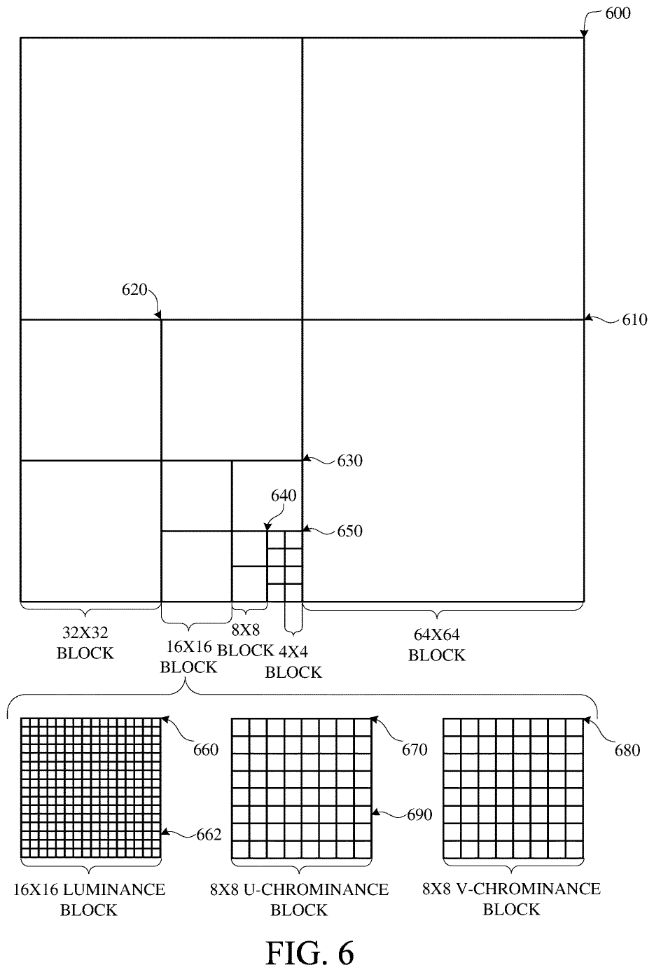

FIG. 6 is a block diagram of a representation of a portion 600 of a frame, such as the frame 330 shown in FIG. 3, in accordance with implementations of this disclosure. As shown, the portion 600 of the frame includes four 64×64 blocks 610, in two rows and two columns in a matrix or Cartesian plane. In some implementations, a 64×64 block may be a maximum coding unit, N=64. Each 64×64 block may include four 32×32 blocks 620. Each 32×32 block may include four 16×16 blocks 630. Each 16×16 block may include four 8×8 blocks 640. Each 8×8 block 640 may include four 4×4 blocks 650. Each 4×4 block 650 may include 16 pixels, which may be represented in four rows and four columns in each respective block in the Cartesian plane or matrix. The pixels may include information representing an image captured in the frame, such as luminance information, color information, and location information. In some implementations, a block, such as a 16×16 pixel block as shown, may include a luminance block 660, which may include luminance pixels 662; and two chrominance blocks 670, 680, such as a U or Cb chrominance block 670, and a V or Cr chrominance block 680. The chrominance blocks 670, 680 may include chrominance pixels 690. For example, the luminance block 660 may include 16×16 luminance pixels 662 and each chrominance block 670, 680 may include 8×8 chrominance pixels 690 as shown. Although one arrangement of blocks is shown, any arrangement may be used. Although FIG. 6 shows N×N blocks, in some implementations, N×M blocks may be used. For example, 32×64 blocks, 64×32 blocks, 16×32 blocks, 32×16 blocks, or any other size blocks may be used. In some implementations, N×2N blocks, 2N×N blocks, or a combination thereof may be used.

In some implementations, video coding may include ordered block-level coding. Ordered block-level coding may include coding blocks of a frame in an order, such as raster-scan order, wherein blocks may be identified and processed starting with a block in the upper left corner of the frame, or portion of the frame, and proceeding along rows from left to right and from the top row to the bottom row, identifying each block in turn for processing. For example, the 64×64 block in the top row and left column of a frame may be the first block coded and the 64×64 block immediately to the right of the first block may be the second block coded. The second row from the top may be the second row coded, such that the 64×64 block in the left column of the second row may be coded after the 64×64 block in the rightmost column of the first row.

In some implementations, coding a block may include using quad-tree coding, which may include coding smaller block units within a block in raster-scan order. For example, the 64×64 block shown in the bottom left corner of the portion of the frame shown in FIG. 6, may be coded using quad-tree coding wherein the top left 32×32 block may be coded, then the top right 32×32 block may be coded, then the bottom left 32×32 block may be coded, and then the bottom right 32×32 block may be coded. Each 32×32 block may be coded using quad-tree coding wherein the top left 16×16 block may be coded, then the top right 16×16 block may be coded, then the bottom left 16×16 block may be coded, and then the bottom right 16×16 block may be coded. Each 16×16 block may be coded using quad-tree coding wherein the top left 8×8 block may be coded, then the top right 8×8 block may be coded, then the bottom left 8×8 block may be coded, and then the bottom right 8×8 block may be coded. Each 8×8 block may be coded using quad-tree coding wherein the top left 4×4 block may be coded, then the top right 4×4 block may be coded, then the bottom left 4×4 block may be coded, and then the bottom right 4×4 block may be coded. In some implementations, 8×8 blocks may be omitted for a 16×16 block, and the 16×16 block may be coded using quad-tree coding wherein the top left 4×4 block may be coded, then the other 4×4 blocks in the 16×16 block may be coded in raster-scan order.

In some implementations, video coding may include compressing the information included in an original, or input, frame by, for example, omitting some of the information in the original frame from a corresponding encoded frame. For example, coding may include reducing spectral redundancy, reducing spatial redundancy, reducing temporal redundancy, or a combination thereof.

In some implementations, reducing spectral redundancy may include using a color model based on a luminance component (Y) and two chrominance components (U and V or Cb and Cr), which may be referred to as the YUV or YCbCr color model, or color space. Using the YUV color model may include using a relatively large amount of information to represent the luminance component of a portion of a frame and using a relatively small amount of information to represent each corresponding chrominance component for the portion of the frame. For example, a portion of a frame may be represented by a high-resolution luminance component, which may include a 16×16 block of pixels, and by two lower resolution chrominance components, each of which represents the portion of the frame as an 8×8 block of pixels. A pixel may indicate a value, for example, a value in the range from 0 to 255, and may be stored or transmitted using, for example, eight bits. Although this disclosure is described in reference to the YUV color model, any color model may be used.

In some implementations, reducing spatial redundancy may include transforming a block into the frequency domain using, for example, a discrete cosine transform (DCT). For example, a unit of an encoder, such as the transform unit 420 shown in FIG. 4, may perform a DCT using transform coefficient values based on spatial frequency.

In some implementations, reducing temporal redundancy may include using similarities between frames to encode a frame using a relatively small amount of data based on one or more reference frames, which may be previously encoded, decoded, and reconstructed frames of the video stream. For example, a block or pixel of a current frame may be similar to a spatially corresponding block or pixel of a reference frame. In some implementations, a block or pixel of a current frame may be similar to block or pixel of a reference frame at a different spatial location and reducing temporal redundancy may include generating motion information indicating the spatial difference, or translation, between the location of the block or pixel in the current frame and corresponding location of the block or pixel in the reference frame.

In some implementations, reducing temporal redundancy may include identifying a portion of a reference frame that corresponds to a current block or pixel of a current frame. For example, a reference frame, or a portion of a reference frame, which may be stored in memory, may be searched to identify a portion for generating a prediction to use for encoding a current block or pixel of the current frame with maximal efficiency. For example, the search may identify a portion of the reference frame for which the difference in pixel values between the current block and a prediction block generated based on the portion of the reference frame is minimized and may be referred to as motion searching. In some implementations, the portion of the reference frame searched may be limited. For example, the portion of the reference frame searched, which may be referred to as the search area, may include a limited number of rows of the reference frame. In an example, identifying the portion of the reference frame for generating a prediction may include calculating a cost function, such as a sum of absolute differences (SAD), between the pixels of portions of the search area and the pixels of the current block.

In some implementations, the spatial difference between the location of the portion of the reference frame for generating a prediction in the reference frame and the current block in the current frame may be represented as a motion vector. The difference in pixel values between the prediction block and the current block may be referred to as differential data, residual data, a prediction error, or as a residual block. In some implementations, generating motion vectors may be referred to as motion estimation, and a pixel of a current block may be indicated based on location using Cartesian coordinates as f_{x, y}. Similarly, a pixel of the search area of the reference frame may be indicated based on location using Cartesian coordinates as r_{x, y}. A motion vector (MV) for the current block may be determined based on, for example, a SAD between the pixels of the current frame and the corresponding pixels of the reference frame.

Although described herein with reference to matrix or Cartesian representation of a frame for clarity, a frame may be stored, transmitted, processed, or any combination thereof, in any data structure such that pixel values may be efficiently represented for a frame or image. For example, a frame may be stored, transmitted, processed, or any combination thereof, in a two-dimensional data structure such as a matrix as shown, or in a one-dimensional data structure, such as a vector array. In an implementation, a representation of the frame, such as a two-dimensional representation as shown, may correspond to a physical location in a rendering of the frame as an image. For example, a location in the top left corner of a block in the top left corner of the frame may correspond with a physical location in the top left corner of a rendering of the frame as an image.

In some implementations, block-based coding efficiency may be improved by partitioning input blocks into one or more prediction partitions, which may be rectangular, including square, partitions for prediction coding. In some implementations, video coding using prediction partitioning may include selecting a prediction partitioning scheme from among multiple candidate prediction partitioning schemes. For example, in some implementations, candidate prediction partitioning schemes for a 64×64 coding unit may include rectangular size prediction partitions ranging in sizes from 4×4 to 64×64, such as 4×4, 4×8, 8×4, 8×8, 8×16, 16×8, 16×16, 16×32, 32×16, 32×32, 32×64, 64×32, or 64×64. In some implementations, video coding using prediction partitioning may include a full prediction partition search, which may include selecting a prediction partitioning scheme by encoding the coding unit using each available candidate prediction partitioning scheme and selecting the best scheme, such as the scheme that produces the least rate-distortion error.

In some implementations, encoding a video frame may include identifying a prediction partitioning scheme for encoding a current block, such as block 610. In some implementations, identifying a prediction partitioning scheme may include determining whether to encode the block as a single prediction partition of maximum coding unit size, which may be 64×64 as shown, or to partition the block into multiple prediction partitions, which may correspond with the sub-blocks, such as the 32×32 blocks 620 the 16×16 blocks 630, or the 8×8 blocks 640, as shown, and may include determining whether to partition into one or more smaller prediction partitions. For example, a 64×64 block may be partitioned into four 32×32 prediction partitions. Three of the four 32×32 prediction partitions may be encoded as 32×32 prediction partitions and the fourth 32×32 prediction partition may be further partitioned into four 16×16 prediction partitions. Three of the four 16×16 prediction partitions may be encoded as 16×16 prediction partitions and the fourth 16×16 prediction partition may be further partitioned into four 8×8 prediction partitions, each of which may be encoded as an 8×8 prediction partition. In some implementations, identifying the prediction partitioning scheme may include using a prediction partitioning decision tree.

In some implementations, video coding for a current block may include identifying an optimal prediction coding mode from multiple candidate prediction coding modes, which may provide flexibility in handling video signals with various statistical properties and may improve the compression efficiency. For example, a video coder may evaluate each candidate prediction coding mode to identify the optimal prediction coding mode, which may be, for example, the prediction coding mode that minimizes an error metric, such as a rate-distortion cost, for the current block. In some implementations, the complexity of searching the candidate prediction coding modes may be reduced by limiting the set of available candidate prediction coding modes based on similarities between the current block and a corresponding prediction block. In some implementations, the complexity of searching each candidate prediction coding mode may be reduced by performing a directed refinement mode search. For example, metrics may be generated for a limited set of candidate block sizes, such as 16×16, 8×8, and 4×4, the error metric associated with each block size may be in descending order, and additional candidate block sizes, such as 4×8 and 8×4 block sizes, may be evaluated.

In some implementations, block-based coding efficiency may be improved by partitioning a current residual block into one or more transform partitions, which may be rectangular, including square, partitions for transform coding. In some implementations, video coding, such as video coding using transform partitioning, may include selecting a uniform transform partitioning scheme. For example, a current residual block, such as block 610, may be a 64×64 block and may be transformed without partitioning using a 64×64 transform.

Although not expressly shown in FIG. 6, a residual block may be transform partitioned using a uniform transform partitioning scheme. For example, a 64×64 residual block may be transform partitioned using a uniform transform partitioning scheme including four 32×32 transform blocks, using a uniform transform partitioning scheme including sixteen 16×16 transform blocks, using a uniform transform partitioning scheme including sixty-four 8×8 transform blocks, or using a uniform transform partitioning scheme including 256 4×4 transform blocks.

In some implementations, video coding, such as video coding using transform partitioning, may include identifying multiple transform block sizes for a residual block using multiform transform partition coding. In some implementations, multiform transform partition coding may include recursively determining whether to transform a current block using a current block size transform or by partitioning the current block and multiform transform partition coding each partition. For example, the bottom left block 610 shown in FIG. 6 may be a 64×64 residual block, and multiform transform partition coding may include determining whether to code the current 64×64 residual block using a 64×64 transform or to code the 64×64 residual block by partitioning the 64×64 residual block into partitions, such as four 32×32 blocks 620, and multiform transform partition coding each partition. In some implementations, determining whether to transform partition the current block may be based on comparing a cost for encoding the current block using a current block size transform to a sum of costs for encoding each partition using partition size transforms.

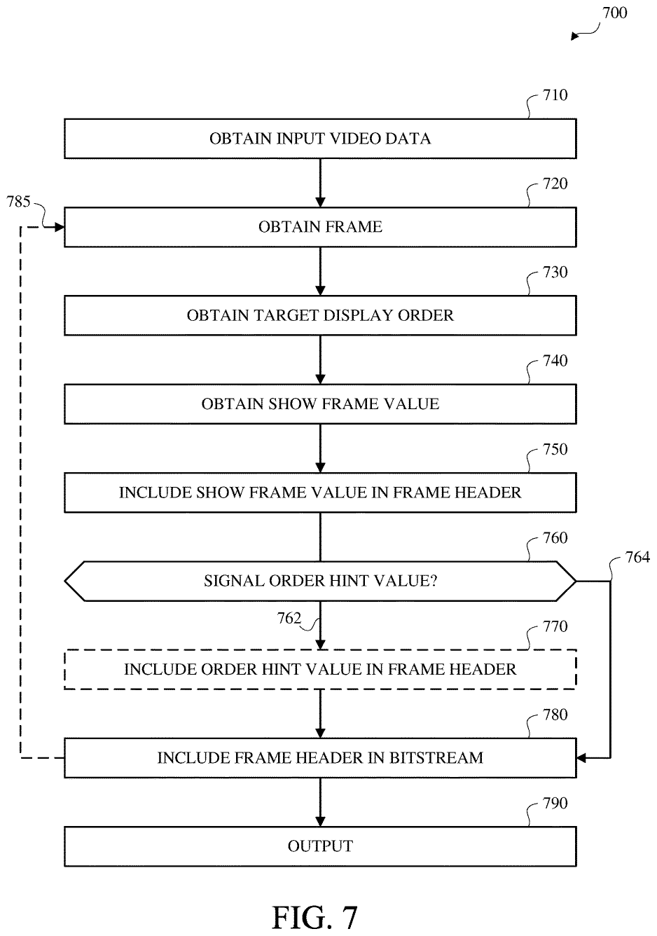

FIG. 7 is a block diagram of an example of encoding using inferred display order hint for show frames 700. Encoding using inferred display order hint for show frames 700 may be implemented by an encoder, such as the encoder 400 shown in FIG. 4.

Encoding using inferred display order hint for show frames 700 includes encoding an input video steam, such as the input video stream 402 shown in FIG. 4, or one or more portions thereof, to generate an encoded (compressed) output bitstream (encoded bitstream), such as the encoded (compressed) bitstream 404 shown in FIG. 4.

In block-based hybrid video coding, to reduce, or minimize, the resource utilization, such as bandwidth utilization, for signaling, storing, or both, compressed, or encoded, video data, redundant data, such as spatially redundant data, temporally redundant data, or both, is omitted or excluded from the compressed, or encoded, data.

Encoding using inferred display order hint for show frames 700 includes obtaining a input video data (at 710), obtaining a frame (at 720), obtaining a target display order value (at 730), obtaining a show frame value (at 740), including the show frame value in a frame header (at 750), determining whether to signal the target display order value (at 760), including the target display order value in the frame header (at 770), including the frame header in the encoded bitstream (at 780), and outputting the encoded bitstream (at 790).

Obtaining a frame (at 720), obtaining a target display order value (at 730), obtaining a show frame value (at 740), including the show frame value in a frame header (at 750), determining whether to signal the target display order value (at 760), including the target display order value in the frame header (at 770), and including the frame header in the encoded bitstream (at 780), may be performed on a per-frame basis for multiple frames as indicated by the broken directional line (at 785) from including the frame header in the encoded bitstream (at 780) to obtaining a frame (at 720).

Although not shown expressly in FIG. 7, encoding using inferred display order hint for show frames 700 includes other aspects of video coding for encoding the current frame or sequence of frames. For example, encoding using inferred display order hint for show frames 700 includes obtaining, or determining, a prediction coding mode, such as an inter prediction coding mode, for coding a current block from the current frame, which includes obtaining a predicted motion vector, which is an optimal candidate, or reference, motion vector, for the current block, such as from one or more context blocks for the current block, obtaining a motion vector for the current block, obtaining encoded block data by encoding the current block using the motion vector, and including the encoded block data in an encoded, or output, bitstream.

The input video data is obtained (at 710). The input video data includes a sequence of frames (input frames). For example, the encoder, or a component thereof, such as an intra/inter prediction unit of the encoder, such as the intra/inter prediction unit 410 shown in FIG. 4, may obtain the input video stream. The sequence of frames may have a defined cardinality, or number, of frames. For example, the sequence of frames may include a first frame, followed by a second frame, followed by a third frame, followed by a fourth frame, followed by a fifth frame, followed by a sixth frame, followed by a seventh frame, followed by an eighth frame, followed by a ninth frame. Any number, or cardinality, of frames may be used.

The current frame for encoding is obtained (at 720) from the sequence of frames from the input video data. The current frame may be obtained (at 720) subsequent to encoding one or more other frames, such as a frame sequentially preceding the current frame in the input video stream, and generating, or otherwise obtaining, a corresponding reconstructed frame (or frames), or one or more portions thereof, for use as a reference frame (or frames) for encoding the current frame.

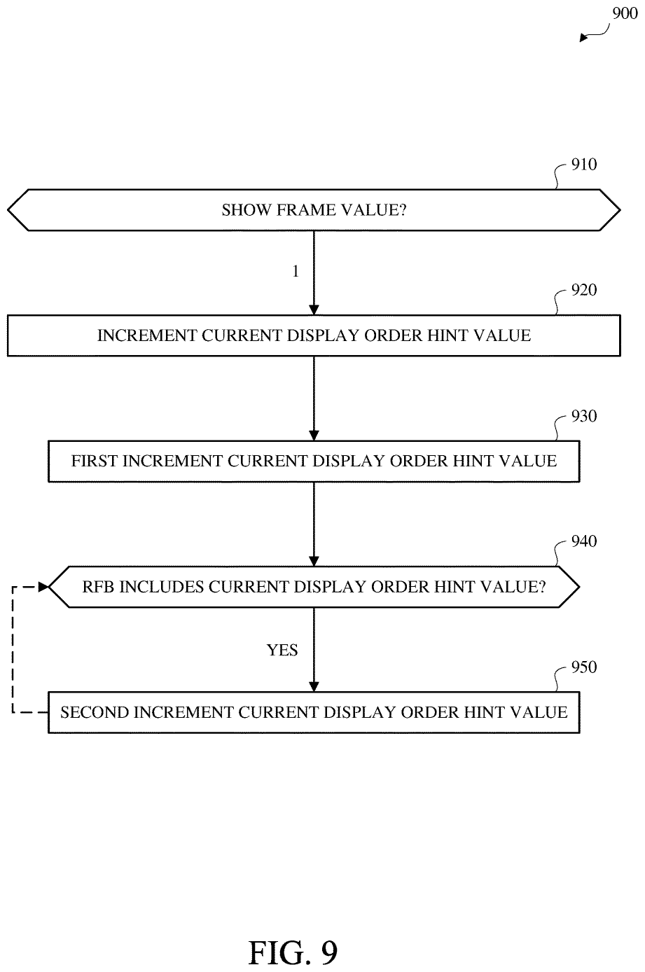

The encoding order for the sequence of frames may differ from the input order, the display order, or both for the sequence of frames. An example showing a coding order that differs from the display order is shown in FIG. 9.

For example, the first frame encoded (coding order 0) may be the first frame in input order (frame 0) which may have the first target display order (display order 0). The second frame encoded (coding order 1) may be the ninth frame in input order (frame 8) which may have the ninth target display order (display order 8). The third frame encoded (coding order 2) may be the fifth frame in input order (frame 4) which may have the fifth target display order (display order 4). The fourth frame encoded (coding order 3) may be the third frame in input order (frame 2) which may have the third target display order (display order 2). The fifth frame encoded (coding order 4) may be the second frame in input order (frame 1) which may have the second target display order (display order 1). The sixth frame encoded (coding order 5) may be the fourth frame in input order (frame 3) which may have the fourth target display order (display order 3). The seventh frame encoded (coding order 6) may be the seventh frame in input order (frame 6) which may have the seventh target display order (display order 6). The eighth frame encoded (coding order 7) may be the sixth frame in input order (frame 5) which may have the sixth target display order (display order 5). The ninth frame encoded (coding order 8) may be the eighth frame in input order (frame 7) which may have the eighth target display order (display order 7). Other coding orders may be used.

In some implementations, the current frame may be obtained (at 720) by generating the current frame as a constructed reference frame, which is a non-display frame, and which differs from the frames from the sequence of frames.

The target display order value for the current frame is obtained (at 730). The target display order value for the current frame may be an integer value, such as a positive integer value. The target display order value for the current frame may be the position, or location, of the current frame in the sequence of frames.

In an example, the current frame is the temporally, or sequentially, earliest, or first, frame from the sequence of frames and the target display order value for the current frame is zero (0). In some implementations, the current frame may be the temporally, or sequentially, earliest, or first, frame from the sequence of frames and the target display order value for the current frame may be one (1).

In another example, the current frame is the second frame from the sequence of frames, subsequent to the first frame, and the target display order value is one (1), wherein the target display order value for the first frame is zero (0).

In another example, the current frame is the third frame from the sequence of frames, subsequent to the second frame, and the target display order value is two (2), wherein the target display order value for the first frame is zero (0).

In another example, the current frame is the fourth frame from the sequence of frames, subsequent to the third frame, and the target display order value is three (3), wherein the target display order value for the first frame is zero (0).

In another example, the current frame is the fifth frame from the sequence of frames, subsequent to the fourth frame, and the target display order value is four (4), wherein the target display order value for the first frame is zero (0).

In another example, the current frame is the sixth frame from the sequence of frames, subsequent to the fifth frame, and the target display order value is five (5), wherein the target display order value for the first frame is zero (0).

In another example, the current frame is the seventh frame from the sequence of frames, subsequent to the sixth frame, and the target display order value is six (6), wherein the target display order value for the first frame is zero (0).

In another example, the current frame is the eighth frame from the sequence of frames, subsequent to the seventh frame, and the target display order value is seven (7), wherein the target display order value for the first frame is zero (0).

In another example, the current frame is the ninth frame from the sequence of frames, subsequent to the eighth frame, and the target display order value is eight (8), wherein the target display order value for the first frame is zero (0).

In some implementations, the current frame may be a non-display frame and obtaining the target display order value for the current frame (at 730) may be omitted. In some implementations, the current frame may be a non-display frame and obtaining the target display order value for the current frame (at 730) may include obtaining a value other than a value corresponding to the position, or location, of the frames in the sequence of frames, such as negative one (−1). In some implementations, the current frame may be a non-display frame and obtaining the target display order value for the current frame (at 730) includes obtaining another value as the target display order value.

Although not expressly shown in FIG. 7, in some implementations, encoding using inferred display order hint for show frames 700 includes determining whether using inferred display order hint for show frames is enabled for the sequence of frames.

Although not expressly shown in FIG. 7, in some implementations, encoding using inferred display order hint for show frames 700 includes, in response to determining that using inferred display order hint for show frames is enabled for the sequence of frames, the encoder includes, in the encoded bitstream, such as in a header for the sequence of frames, a syntax element indicating that using inferred display order hint for show frames is enabled for the sequence of frames, which indicates that one or more order hint values may be absent from the encoded bitstream for the current frame. In some implementations, encoding using inferred display order hint for show frames 700 includes, in response to determining that using inferred display order hint for show frames is disabled, or otherwise unavailable, for the sequence of frames, the encoder includes, in the encoded bitstream, such as in a header for the sequence of frames, a syntax element indicating that using inferred display order hint for show frames is disabled for the sequence of frames, which indicates that the order hint value is included in the encoded bitstream for the current frame.

A show frame value is obtained for the current frame (at 740). The show frame value for the current frame is a first defined show frame value, such as one (1), or a second defined show frame value, such as zero (0). In some implementations, the show frame value is a bit, a symbol, or a flag.

In an example, the current frame is the temporally, or sequentially, earliest, or first, frame from the sequence of frames, the target display order value for the current frame is zero (0), and the show frame value for the first frame is one (1).

In another example, the current frame is the second frame from the sequence of frames, subsequent to the first frame, the target display order value is one (1), wherein the target display order value for the first frame is zero (0), and the show frame value for the current frame is one (1).

In another example, the current frame is the third frame from the sequence of frames, subsequent to the second frame, the target display order value is two (2), wherein the target display order value for the first frame is zero (0), and the show frame value for the current frame is zero (0).

In another example, the current frame is the fourth frame from the sequence of frames, subsequent to the third frame, the target display order value is three (3), wherein the target display order value for the first frame is zero (0), and the show frame value for the current frame is one (1).

In another example, the current frame is the fifth frame from the sequence of frames, subsequent to the fourth frame, the target display order value is four (4), wherein the target display order value for the first frame is zero (0), and the show frame value for the current frame is zero (0).

In another example, the current frame is the sixth frame from the sequence of frames, subsequent to the fifth frame, the target display order value is five (5), wherein the target display order value for the first frame is zero (0), and the show frame value for the current frame is one (1).

In another example, the current frame is the seventh frame from the sequence of frames, subsequent to the sixth frame, the target display order value is six (6), wherein the target display order value for the first frame is zero (0), and the show frame value for the current frame is zero (0).

In another example, the current frame is the eighth frame from the sequence of frames, subsequent to the seventh frame, the target display order value is seven (7), wherein the target display order value for the first frame is zero (0), and the show frame value for the current frame is one (1).

In another example, the current frame is the ninth frame from the sequence of frames, subsequent to the eighth frame, the target display order value is eight (8), wherein the target display order value for the first frame is zero (0), and the show frame value for the current frame is zero (0).

The show frame value for the current frame is included in a frame header for the current frame (at 750).

The encoder determines whether to signal the target display order (at 760). The encoder determines whether to signal the target display order in accordance with the show frame value for the current frame.

In an example, the show frame value for the current frame is the second defined show frame value, zero (0), and the encoder determines to signal the target display order for the current frame (as shown at 762).

In another example, the show frame value for the current frame is the first defined show frame value, one (1), and the encoder determines to omit signaling the target display order for the current frame (as shown at 764).

In response to determining that the show frame value for the current frame is the second defined show frame value, zero (0), the encoder includes the target display order value as an order hint value in the frame header for the current frame (at 770). Including the target display order value as the order hint value in the frame header for the current frame (at 770) is shown with a broken line border to indicate that including the target display order value as the order hint value in the frame header for the current frame (at 770) is omitted, skipped, avoided, or excluded in response to determining that the show frame value for the current frame is the first defined show frame value, one (1).

In codecs that omit encoding using inferred display order hint for show frames 700, the order hint value signaled in the encoded bitstream may differ from the target display order for the respective frame. In encoding using inferred display order hint for show frames 700, the order hint value signaled in the encoded bitstream matches the target display order for the respective frame.

Including the target display order value as the order hint value in the frame header for the current frame (at 770) includes including the target display order value as the order hint value in the frame header for the current frame (at 770) using a defined number, count, or cardinality, of bits (N). The encoder may determine the defined number, count, or cardinality, of bits (N) for signaling the order hint value. The encoder may signal the defined number, count, or cardinality, of bits (N) for signaling the order hint value. For example, the encoder may signal the defined number, count, or cardinality, of bits (N) for signaling the order hint value as a three-bit value, variable, or parameter. The encoder may determine the defined number, count, or cardinality, of bits (N) for signaling the order hint value within a defined range such as from one to eight ([1, 8]). For example, the defined number, count, or cardinality, of bits (N) for signaling the order hint value may be seven (7) bits.

In response to determining that the show frame value for the current frame is the first defined show frame value, one (1), the encoder omits, avoids, or excludes, including the target display order value as the order hint value in the frame header for the current frame.

For example, including the target display order value as the order hint value in the frame header for the current frame (at 770) based on determining whether the show frame value for the current frame is the first defined show frame value or the second defined show frame value (at 760) may be expressed as the following:

```
if (seq_params->order_hint_info.enable_order_hint) {
  if (!cm->show_frame)
    aom_wb_write_literal(wb, current_frame->order_hint,
    seq_params->order_hint_info.order_hint_bits_minus_1 + 1);}.
```

In some implementations, the target display order value may be included as the order hint value in the frame header for the current frame (at 770) subsequent to the show frame value for the current frame wherein a reduced still picture header value, bit, symbol, or flag for the current frame is zero (0)

The encoder includes the frame header for the current frame in the encoded bitstream (at 780). Although not shown in FIG. 7, the encoder includes encoded frame data for the current frame in the encoded bitstream.

The encoder encodes the other frames from the sequence of frames, which may include encoding one or more constructed reference frames, and includes the corresponding encoded frame data in the encoded bitstream, which, for a respective frame, includes obtaining the respective frame (at 720), obtaining a target display order value for the respective frame (at 730), obtaining a show frame value for the respective frame (at 740), including the show frame value in a frame header for the respective frame (at 750), determining whether to signal the target display order value for the respective frame (at 760), including the target display order value in the frame header for the respective frame (at 770), and including the frame header for the respective frame in the encoded bitstream (at 780).

The output, compressed, or encoded, bitstream, including the frame header for the current frame is output, such as stored or transmitted, such as to a decoder, (at 790).

In some implementations, determining whether to signal the target display order value for the respective frame (at 760) may be omitted, avoided, or skipped, and the target display order value may be included in the respective frame header for the respective frames (at 770).

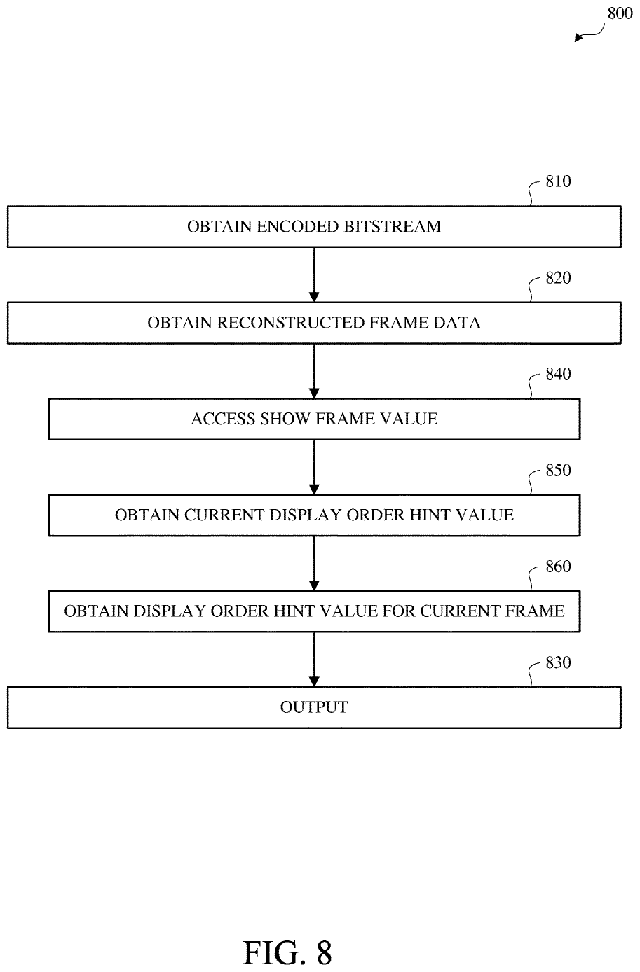

Although not expressly shown in FIG. 7, the encoder may include a decode path, which may be similar to the decode path shown (at 450, 460, 470, 480, and 482) in FIG. 4, except as is described herein or as is otherwise clear from context, which may implement decoding using inferred display order hint for show frames as shown (at 800) in FIG. 8, or one or more portions thereof.

FIG. 8 is a flowchart diagram of an example of decoding using inferred display order hint for show frames 800 in accordance with implementations of this disclosure. Decoding using inferred display order hint for show frames 800 may be implemented in a decoder, such as the decoder 500 shown in FIG. 5.

Decoding using inferred display order hint for show frames 800 includes decoding an encoded bitstream, such as the compressed bitstream 502 shown in FIG. 5, or one or more portions thereof, to generate a reconstructed video, or a portion thereof, such as the output video stream 504 shown in FIG. 5.

Decoding using inferred display order hint for show frames 800 includes generating reconstructed video data by decoding an encoded bitstream. Decoding the encoded bitstream includes obtaining reconstructed frame data for a current frame of a sequence of frames.

Decoding using inferred display order hint for show frames 800 includes obtaining the encoded bitstream (at 810), obtaining reconstructed frame data (at 820), and outputting (at 830). One or more aspects of decoding using inferred display order hint for show frames 800 may be omitted from the description herein for simplicity and brevity.

The encoded bitstream is obtained (at 810). For example, the decoder, or a component thereof, such as an intra/inter prediction unit of the decoder, such as the entropy decoding unit 510 shown in FIG. 5, may obtain the encoded bitstream. Obtaining the encoded bitstream includes identifying a current frame from a current sequence of frames to decode from the encoded bitstream to generate a current reconstructed frame.

The reconstructed frame data for the current frame is obtained (at 820). Obtaining the reconstructed frame data for the current frame includes accessing a show frame value (at 840), obtaining a current display order hint value (at 850), and obtaining a display order hint value for the current frame (at 860).

The show frame value is accessed for the current frame (at 840). A frame header for the current frame is received, read, obtained, or otherwise accessed, from the encoded bitstream (at 840). For example, the frame header for the current frame may be an uncompressed frame header. The frame header for the current frame includes a show frame value for the current frame. The decoder accesses, or otherwise obtains, the show frame value for the current frame from the frame header for the current frame (at 840).

The current display order hint value is obtained (at 850). The current display order hint value may be implemented as a variable (curr_display_order_hint). An example of obtaining the current display order hint value is shown in FIG. 9.

Prior to decoding the current sequence of frames, prior to decoding a first frame, in sequential decoding order, from the current sequence of frames, or prior to obtaining the current display order hint value (at 850) with respect to decoding the first frame, in sequential decoding order, from the current sequence of frames, the current display order hint value is a defined value (defined initiation value), such as negative one (−1). For example, the current display order hint value may be initiated to the defined value prior to decoding the current sequence of frames or prior to decoding a first frame, in sequential decoding order, from the current sequence of frames.

Prior to obtaining the current display order hint value (at 850) with respect to decoding a frame subsequent to the first frame, in sequential decoding order, from the current sequence of frames, the current display order hint value is a previously obtained current display order hint value previously obtained in accordance with obtaining the previously reconstructed frame data.

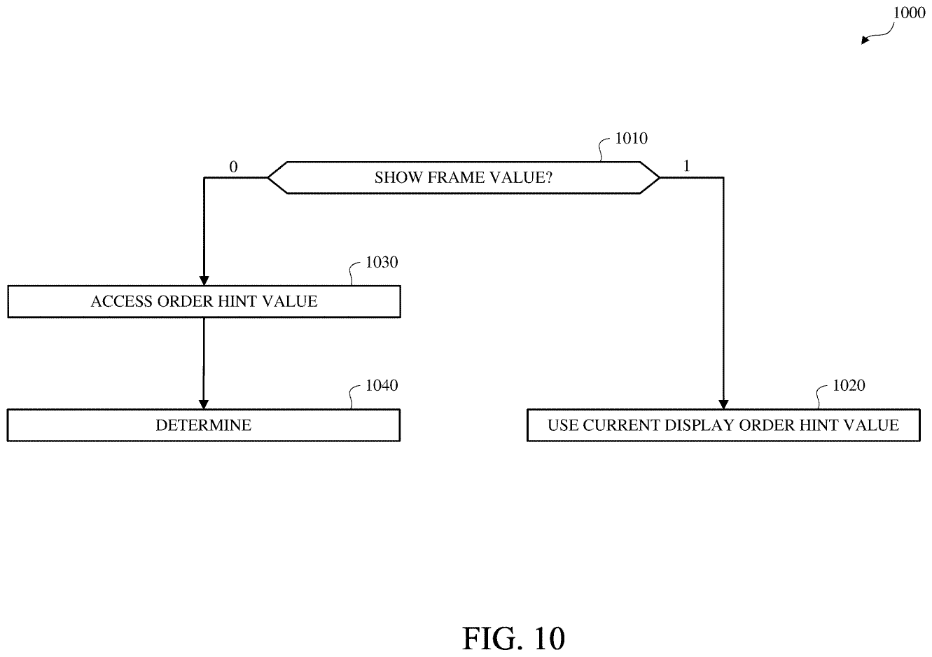

The display order hint value for the current frame is obtained (at 860). The decoder, or a component thereof, may include the display order hint value for the current frame in the reconstructed frame data for the current frame. An example of obtaining the display order hint value for the current frame is shown in FIG. 10.

The decoder, or a component thereof, outputs the reconstructed frame data for the current frame to the reference frame buffer (at 830), such as by storing, or otherwise including, the reconstructed frame data for the current frame in the reference frame buffer (RFB).

Outputting the reconstructed frame data for the current frame (at 830) includes outputting the reconstructed frame data for the current frame for presentation or display in accordance with the display order hint value for the current frame. For example, the decoder may include the reconstructed frame data for the current frame in the reconstructed video data at a display order position corresponding to the display order hint value for the current frame and may output the reconstructed video data for presentation or display. Outputting the reconstructed video data may include storing the reconstructed video data. Although FIG. 8 is described with respect to a current frame, decoding using inferred display order hint for show frames 800 may be performed, such as on a per-frame basis, for the sequence of frames or for multiple sequences of frames.

FIG. 9 is a flowchart diagram of an example of obtaining a current display order hint value 900 in accordance with implementations of this disclosure. Obtaining the current display order hint value 900 may be implemented in a decoder, such as the decoder 500 shown in FIG. 5.

Obtaining the current display order hint value 900 includes determining whether the show frame value for the current frame is the first defined show frame value (at 910) and incrementing the current display order hint value (at 920).

The decoder determines whether the show frame value for the current frame is the first defined show frame value, one (1), (at 910).

In an example, the show frame value for the current frame is the second defined show frame value, zero (0) (show_frame=0) and the decoder determines that the show frame value for the current frame is other than the first defined show frame value, one (1), (at 910). In response to determining that the show frame value for the current frame is other than the first defined show frame value, one (1), (at 910), the decoder omits, skips, avoids, or excludes incrementing the current display order hint value (at 920).

In another example, the show frame value for the current frame is the first defined show frame value, one (1) (show_frame=1) and the decoder determines that the show frame value for the current frame is the first defined show frame value, one (1), (at 910).

In response to determining that the show frame value for the current frame is the first defined show frame value, one (1), (at 910) the decoder increments the current display order hint value (at 920).

Incrementing the current display order hint value includes first incrementing the current display order hint value (at 930), determining whether the reference frame buffer includes the current display order hint value (at 940), and second incrementing the current display order hint value (at 950).

First incrementing the current display order hint value (at 930) includes incrementing, such as by adding one (1), the current display order hint value.

Subsequent to first incrementing the current display order hint value (at 930), the decoder determines whether the reference frame buffer includes reference frame data, for a previously reconstructed, or constructed, reference frame (previously reconstructed frame data), which includes a previously reconstructed display order hint value for the reference frame that matches the current display order hint value (at 940).

Determining whether the reference frame buffer includes reference frame data, for a previously reconstructed, or constructed, reference frame, which includes a previously reconstructed display order hint value that matches the current display order hint value (at 940) is shown as “RFB INCLUDES CURRENT DISPLAY ORDER HINT VALUE?” in FIG. 9 for simplicity and brevity.

In an example, the decoder determines that the reference frame buffer includes reference frame data, for a previously reconstructed, or constructed, reference frame, which includes a previously reconstructed display order hint value that matches the current display order hint value (YES).

In another example, the decoder determines that reference frame data, for a previously reconstructed, or constructed, reference frame, which includes a previously reconstructed display order hint value that matches the current display order hint value is absent, omitted, or unavailable, from the reference frame buffer (not expressly shown).

In response to determining that the reference frame buffer includes reference frame data, for a previously reconstructed, or constructed, reference frame, which includes a previously reconstructed display order hint value that matches the current display order hint value (at 940), the decoder second increments the current display order hint value (at 950). Second incrementing the current display order hint value (at 950) includes incrementing, such as by adding one (1), the current display order hint value.

In some implementations, the reference frame buffer includes previously reconstructed frame data for multiple, such as a plurality of, previously reconstructed frames (reference fames) and determining that the reference frame buffer includes the previously reconstructed frame data that includes the previously reconstructed display order hint value that matches the current display order hint value (at 940) and second incrementing the current display order hint value (at 950) are performed iteratively, on a per-previously reconstructed frame basis, as indicated by the broken directional line from second incrementing the current display order hint value (at 950) to and determining that the reference frame buffer includes the previously reconstructed frame data that includes the previously reconstructed display order hint value that matches the current display order hint value (at 940).

In response to determining that that reference frame data, for a previously reconstructed, or constructed, reference frame, which includes a previously reconstructed display order hint value that matches the current display order hint value is absent, omitted, or unavailable, from the reference frame buffer, the decoder omits, skips, or avoids, second incrementing the current display order hint value (at 950).

In some implementations, determining whether the reference frame buffer includes reference frame data, for a previously reconstructed, or constructed, reference frame, which includes a previously reconstructed display order hint value that matches the current display order hint value (at 940) includes determining whether the reference frame buffer includes a previously reconstructed, or constructed, reference frame, or is empty, or null. In response to determining that the reference frame buffer is empty, or null, or that a previously reconstructed, or constructed, reference frame is absent from the reference frame buffer, the decoder otherwise omits second incrementing the current display order hint value (at 950).

In some implementations, determining whether the reference frame buffer includes reference frame data, for a previously reconstructed, or constructed, reference frame, which includes a previously reconstructed display order hint value that matches the current display order hint value (at 940) includes determining whether the previously reconstructed reference frame is a showable frame, such as a frame other than a constructed reference frame, or a frame otherwise identified as non-showable. For example, the decoder may determine whether a showable frame value from the reference frame data, for the previously reconstructed reference frame indicates that the previously reconstructed reference frame is a showable frame. In response to determining that the previously reconstructed reference frame is other than a showable frame, the decoder otherwise omits second incrementing the current display order hint value (at 950) with respect to the previously reconstructed reference frame.

For example, obtaining the current display order hint value 900 may be expressed as the following:

```
if (cm->show_frame) {
  ++cm->curr_display_order_hint;
  for (int i = 0; i < REF_FRAMES; i++) {
    if (cm->ref_frame_map[i] == NULL) continue;
    if (cm->ref_frame_map[i]->showable_frame == 1 &&
      cm->ref_frame_map[i]->display_order_hint ==
      cm->curr_display_order_hint) {
    ++cm->curr_display_order_hint;
    }
  }
}
```

A description of video coding including obtaining the current display order hint value 900 (increment_curr_display_order_hint) may be expressed as shown in Table 1.

TABLE 1

| | |
|---|---|
| show_frame | f(1) |
| if ( show_frame && decoder_model_info_present_flag | |
| && !equal_picture_interval ) { | |
| temporal point_info( ) | |
| } | |
| if ( show_frame ) { | |
| showable_frame = frame_type != KEY_FRAME | |
| } else { | |
| showable_frame | f(1) |
| } | |
| if ( frame_type == SWITCH_FRAME \|\| | |
| ( frame_type == KEY_FRAME && show_frame ) ) | |
| error_resilient_mode = 1 | |
| else | |
| error_resilient_mode | f(1) |
| increment_crr_display_order_hint | |
| } | |

FIG. 10 is a flowchart diagram of an example of obtaining a display order hint value for a current frame 1000 in accordance with implementations of this disclosure. Obtaining the display order hint value for the current frame 1000 may be implemented in a decoder, such as the decoder 500 shown in FIG. 5.

Obtaining the display order hint value for the current frame 1000 includes determining whether the show frame value for the current frame is the first defined show frame value (at 1010), using the current display order hint value (at 1020), accessing the order hint value (at 1030), and determining the display order hint value for the current frame (at 1040).

The decoder determines whether the show frame value for the current frame is the first defined show frame value, one (1), (at 1010).

In an example, the show frame value for the current frame is the second defined show frame value, zero (0) (show_frame=0) and the decoder determines that the show frame value for the current frame is other than the first defined show frame value, one (1), (at 1010).

In another example, the show frame value for the current frame is the first defined show frame value, one (1) (show_frame=1) and the decoder determines that the show frame value for the current frame is the first defined show frame value, one (1), (at 1010).

In response to determining that the show frame value for the current frame is the first defined show frame value, one (1), (at 1010) the decoder obtains, as the display order hint value for a current frame, the current display order hint value (at 1020), or otherwise uses the current display order hint value as the display order hint value for a current frame. The decoder omits, avoids, skips, or otherwise excludes accessing an order hint value for the current frame from the encoded bitstream, wherein an order hint value for the current frame is absent from the encoded bitstream.

In response to determining that the show frame value for the current frame is other than the first defined show frame value, one (1), (at 1010), such as in response to determining that the show frame value for the current frame is the second defined show frame value, zero (0), the decoder accesses the order hint value (at 1030) and determines the display order hint value for the current frame (at 1040) in accordance with the order hint value and at least one display order hint value from the previously reconstructed frame data.

Accessing the order hint value (at 1030) includes accessing the order hint value from the encoded bitstream, such as from the frame header.

Obtaining the display order hint value for the current frame 1000 (determine_display_order_hint) may be expressed as the following:

```
if (cm->show_frame) {
  current_frame->display_order_hint = cm->curr_display_order_hint;
} else {
  current_frame->order_hint = aom_rb_read_literal(
    rb, seq_params->order_hint_info.order_hint_bits_minus_1 + 1);
  current_frame->display_order_hint = get_disp_order_hint(cm);
}.
```

A description of video coding including obtaining the display order hint value for the current frame 1000 (determine_display_order_hint) may be expressed as shown in Table 2.

TABLE 2

| | |
|---|---|
| determine_display_order_hint | s( ) |

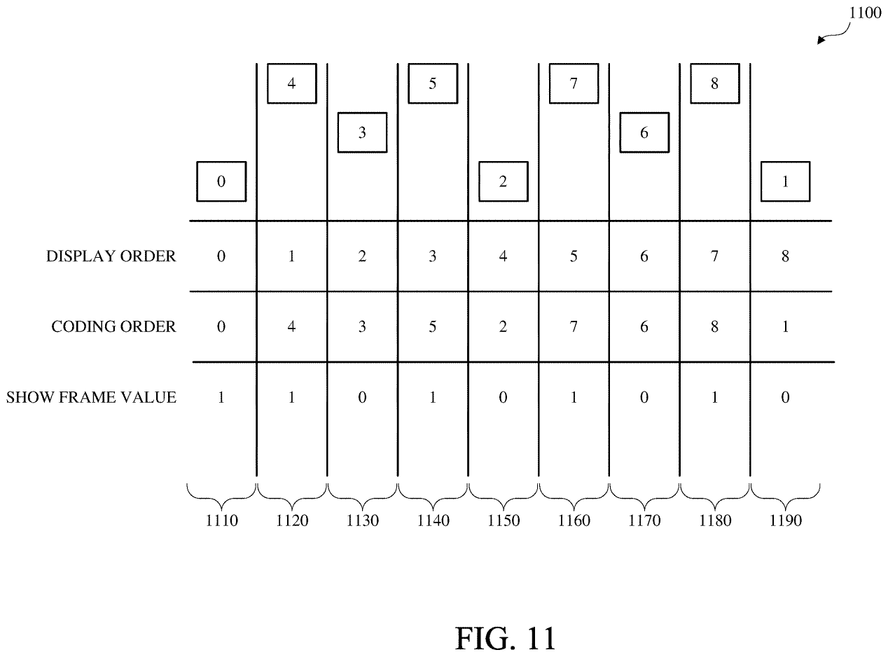

FIG. 11 shows a block diagram of an example of coding using inferred display order hint for show frames for a sequence of frame 1100. The sequence of frame 1100 includes a sequence of nine (9) frames. The example shown in FIG. 11 shows a hierarchical coding structure. The encoding described with respect to FIG. 11 is similar to encoding using inferred display order hint for show frames 700 as shown in FIG. 7, except as is described herein or as is otherwise clear from context. The decoding described with respect to FIG. 11 is similar to decoding using inferred display order hint for show frames 800 as shown in FIGS. 8-10, except as is described herein or as is otherwise clear from context.

For simplicity, the frames are shown in FIG. 11 as rectangles numbered in accordance with the coding order.

In the example shown in FIG. 11, a first frame in input order (frame 0) is the first frame coded (coding order 0), coded with a show frame value of one (1), and has the first target display order (display order 0) as shown at 1110.

Prior to coding the first frame coded (coding order 0) the current display order hint value is negative one (−1) and the reference frame buffer is empty.

Encoding the first frame coded (coding order 0), coded with a show frame value of one (1), omits signaling an order hint value for the first frame or a display order hint value for the first frame.

Decoding the first frame coded (coding order 0), coded with a show frame value of one (1), omits decoding an order hint value for the first frame or a display order hint value for the first frame.

Decoding the first frame coded (coding order 0), coded with a show frame value of one (1), includes first incrementing the current display order hint value, from negative one (−1) to zero (0), such as shown (at 930) in FIG. 9.

Decoding the first frame coded (coding order 0), coded with a show frame value of one (1), includes determining that a reference frame having a display order hint value that matches the current display order hint value is absent from the reference frame buffer, such as shown (at 940) in FIG. 9.

Decoding the first frame coded (coding order 0), coded with a show frame value of one (1), includes storing a first reconstructed frame, generated by decoding the first frame coded (coding order 0), in the reference frame buffer, which includes storing the current display order hint value zero (0) as the display order hint value for the first reconstructed frame, such as shown (at 830) in FIG. 8.

Decoding the first frame coded (coding order 0), coded with a show frame value of one (1), includes outputting the first reconstructed frame for presentation or display in accordance with the display order hint value for the first reconstructed frame, such as by including the first reconstructed frame in the reconstructed video data at a sequentially first position, such as shown (at 830) in FIG. 8.

Subsequent to coding the first frame coded (coding order 0) the current display order hint value is zero (0), the reference frame buffer includes the first reconstructed frame including the display order hint value zero (0), and the reconstructed video data includes the first reconstructed frame at the sequentially first location.

In the example shown in FIG. 11, a ninth frame in input order (frame 8) is the second frame coded (coding order 1), coded with a show frame value of zero (0), and has the ninth target display order (display order 8) as shown at 1190.

Prior to coding the second frame coded (coding order 1) the current display order hint value is zero (0) the reference frame buffer includes the first reconstructed frame including the display order hint value zero (0), and the reconstructed video data includes the first reconstructed frame at the sequentially first location.

Encoding the second frame coded (coding order 1), coded with a show frame value of zero (0), includes signaling an order hint value of eight (8), such as shown (at 770) in FIG. 7.

Decoding the second frame coded (coding order 1), coded with a show frame value of zero (0), includes decoding the order hint value of eight (8) from the encoded bitstream, such as from a header for the second frame coded, such as shown (at 1030) in FIG. 10.

Decoding the second frame coded (coding order 1), coded with a show frame value of zero (0), omits incrementing the current display order hint value.

Decoding the second frame coded (coding order 1), coded with a show frame value of zero (0), includes obtaining a display order hint value for the second frame coded in accordance with the order hint value of eight (8) and at least one display order hint value from the previously reconstructed frame data from the reference frame buffer, such as shown (at 1040) in FIG. 10.

Decoding the second frame coded (coding order 1), coded with a show frame value of zero (0), includes storing a second reconstructed frame, generated by decoding the second frame coded (coding order 1), in the reference frame buffer, which includes storing the display order hint value eight (8) as the display order hint value for the second reconstructed frame, such as shown (at 830) in FIG. 8.

Subsequent to coding the second frame coded (coding order 1) the current display order hint value is zero (0), the reference frame buffer includes the first reconstructed frame including the display order hint value zero (0) and the second reconstructed frame including the display order hint value eight (8), and the reconstructed video data includes the first reconstructed frame at the sequentially first location.

In the example shown in FIG. 11, a fifth frame in input order (frame 4) is the third frame coded (coding order 2), coded with a show frame value of zero (0), and has the fifth target display order (display order 4) as shown at 1150.

Prior to coding the third frame coded (coding order 2) the current display order hint value is zero (0), the reference frame buffer includes the first reconstructed frame including the display order hint value zero (0) and the second reconstructed frame including the display order hint value eight (8), and the reconstructed video data includes the first reconstructed frame at the sequentially first location.

Encoding the third frame coded (coding order 2), coded with a show frame value of zero (0), includes signaling an order hint value of four (4), such as shown (at 770) in FIG. 7.

Decoding the third frame coded (coding order 2), coded with a show frame value of zero (0), omits incrementing the current display order hint value.

Decoding the third frame coded (coding order 2), coded with a show frame value of zero (0), includes decoding the order hint value of four (4), from the encoded bitstream, such as from a header for the third frame coded, such as shown (at 1030) in FIG. 10.

Decoding the third frame coded (coding order 2), coded with a show frame value of zero (0), includes obtaining a display order hint value for the third frame coded (coding order 2) in accordance with the order hint value of four (4) and at least one display order hint value from the previously reconstructed frame data from the reference frame buffer, such as shown (at 1040) in FIG. 10.

Decoding the third frame coded (coding order 2), coded with a show frame value of zero (0), includes storing a third reconstructed frame, generated by decoding the third frame coded (coding order 2), in the reference frame buffer, which includes storing the display order hint value four (4) as the display order hint value for the third reconstructed frame, such as shown (at 830) in FIG. 8.

Subsequent to coding the third frame coded (coding order 2) the current display order hint value is zero (0), the reference frame buffer includes the first reconstructed frame including the display order hint value zero (0), the second reconstructed frame including the display order hint value eight (8), and the third reconstructed frame including the display order hint value four (4), and the reconstructed video data includes the first reconstructed frame at the sequentially first location.

In the example shown in FIG. 11, a third frame in input order (frame 2) is the fourth frame coded (coding order 3), coded with a show frame value of zero (0), and has the third target display order (display order 2) as shown at 1130.

Prior to coding the fourth frame coded (coding order 3) the current display order hint value is zero (0), the reference frame buffer includes the first reconstructed frame including the display order hint value zero (0), the second reconstructed frame including the display order hint value eight (8), and the third reconstructed frame including the display order hint value four (4), and the reconstructed video data includes the first reconstructed frame at the sequentially first location.

Encoding the fourth frame coded (coding order 3), coded with a show frame value of zero (0), includes signaling an order hint value of two (2), such as shown (at 770) in FIG. 7.

Decoding the fourth frame coded (coding order 3), coded with a show frame value of zero (0), includes decoding the display order hint value of two (2), from the encoded bitstream, such as from a header for the fourth frame coded, such as shown (at 1030) in FIG. 10.

Decoding the fourth frame coded (coding order 3), coded with a show frame value of zero (0), omits incrementing the current display order hint value.

Decoding the fourth frame coded (coding order 3), coded with a show frame value of zero (0), includes obtaining a display order hint value for the third frame coded (coding order 2) in accordance with the order hint value of two (2) and at least one display order hint value from the previously reconstructed frame data from the reference frame buffer, such as shown (at 1040) in FIG. 10.

Decoding the fourth frame coded (coding order 3), coded with a show frame value of zero (0), includes storing a fourth reconstructed frame, generated by decoding the fourth frame coded (coding order 3), in the reference frame buffer, which includes storing the display order hint value two (2) as the display order hint value for the fourth reconstructed frame, such as shown (at 830) in FIG. 8.

Subsequent to coding the fourth frame coded (coding order 3) the current display order hint value is zero (0), the reference frame buffer includes the first reconstructed frame including the display order hint value zero (0), the second reconstructed frame including the display order hint value eight (8), the third reconstructed frame including the display order hint value four (4), and the fourth reconstructed frame including the display order hint value two (2), and the reconstructed video data includes the first reconstructed frame at the sequentially first location.

In the example shown in FIG. 11, a second frame in input order (frame 1) is the fifth frame coded (coding order 4), coded with a show frame value of one (1), and has the second target display order (display order 1) as shown at 1120.

Prior to coding the fifth frame coded (coding order 4) the current display order hint value is zero (0), the reference frame buffer includes the first reconstructed frame including the display order hint value zero (0), the second reconstructed frame including the display order hint value eight (8), the third reconstructed frame including the display order hint value four (4), and the fourth reconstructed frame including the display order hint value two (2), and the reconstructed video data includes the first reconstructed frame at the sequentially first location.

Encoding the fifth frame coded (coding order 4), coded with a show frame value of one (1), omits signaling an order hint value for the fifth frame coded or a display order hint value for the fifth frame coded.

Decoding the fifth frame coded (coding order 4), coded with a show frame value of one (1), omits decoding an order hint value for the fifth frame coded or a display order hint value for the fifth frame coded.

Decoding the fifth frame coded (coding order 4), coded with a show frame value of one (1), includes first incrementing the current display order hint value, from zero (0) to one (1), such as shown (at 930) in FIG. 9.

Decoding the fifth frame coded (coding order 4), coded with a show frame value of one (1), includes determining that a reference frame having a display order hint value that matches the current display order hint value is absent from the reference frame buffer, such as shown (at 940) in FIG. 9.

Decoding the fifth frame coded (coding order 4), coded with a show frame value of one (1), includes storing a fifth reconstructed frame, generated by decoding the fifth frame coded (coding order 4), in the reference frame buffer, which includes storing the current display order hint value, one (1), as the display order hint value for the fifth reconstructed frame, such as shown (at 830) in FIG. 8.

Decoding the fifth frame coded (coding order 4), coded with a show frame value of one (1), includes outputting the fifth reconstructed frame for presentation or display in accordance with the display order hint value for the fifth reconstructed frame, such as by including the fifth reconstructed frame in the reconstructed video data at a sequentially second position, such as shown (at 830) in FIG. 8.

Subsequent to coding the fifth frame coded (coding order 4) the current display order hint value is one (1), the reference frame buffer includes the first reconstructed frame including the display order hint value zero (0), the second reconstructed frame including the display order hint value eight (8), the third reconstructed frame including the display order hint value four (4), the fourth reconstructed frame including the display order hint value two (2), and the fifth reconstructed frame including the display order hint value one (1), and the reconstructed video data includes the first reconstructed frame at the sequentially first location followed by the fifth reconstructed frame at the sequentially second location.

Subsequent to coding the fifth frame coded (coding order 4), the encoder includes, in the encoded bitstream, a first show-existing-frame frame header including a flag, bit, or symbol, (show_existing_frame=1) indicating that the fourth reconstructed frame including the display order hint value two (2), previously buffered, or stored, in the reference frame buffer, is to be displayed in accordance with decoding the first show-existing-frame frame header.

Subsequent to coding the fifth frame coded (coding order 4), the decoder receives, reads, obtains, or otherwise accesses, the first show-existing-frame frame header from the encoded bitstream, and, in response, outputs the fourth reconstructed frame for presentation or display, such as by including the fourth reconstructed frame in the reconstructed video data at a sequentially third position.

In the example shown in FIG. 11, a fourth frame in input order (frame 3) is the sixth frame coded (coding order 5), coded with a show frame value of one (1), and has the fourth target display order (display order 3) as shown at 1140.

Prior to coding the sixth frame coded (coding order 5) the current display order hint value is one (1), the reference frame buffer includes the first reconstructed frame including the display order hint value zero (0), the second reconstructed frame including the display order hint value eight (8), the third reconstructed frame including the display order hint value four (4), the fourth reconstructed frame including the display order hint value two (2), and the fifth reconstructed frame including the display order hint value one (1), and the reconstructed video data includes the first reconstructed frame at the sequentially first location followed by the fifth reconstructed frame at the sequentially second location.

Encoding the sixth frame coded (coding order 5), coded with a show frame value of one (1), omits signaling an order hint value for the sixth frame coded or a display order hint value for the sixth frame coded.

Decoding the sixth frame coded (coding order 5), coded with a show frame value of one (1), omits decoding an order hint value for the sixth frame coded or a display order hint value for the sixth frame coded.

Decoding the sixth frame coded (coding order 5), coded with a show frame value of one (1), includes first incrementing the current display order hint value, from one (1) to two (2), such as shown (at 930) in FIG. 9.

Decoding the sixth frame coded (coding order 5), coded with a show frame value of one (1), includes determining that the fourth reconstructed frame including the display order hint value two (2) that matches the current display order hint value is available from the reference frame buffer, such as shown (at 940) in FIG. 9.

Decoding the sixth frame coded (coding order 5), coded with a show frame value of one (1), includes second incrementing the current display order hint value, from two (2) to three (3), such as shown (at 950) in FIG. 9. Decoding the sixth frame coded (coding order 5), coded with a show frame value of one (1), includes storing a sixth reconstructed frame, generated by decoding the sixth frame coded (coding order 5), in the reference frame buffer, which includes storing the current display order hint value, three (3), as the display order hint value for the sixth reconstructed frame, such as shown (at 830) in FIG. 8.

Decoding the sixth frame coded (coding order 5), coded with a show frame value of one (1), includes outputting the sixth reconstructed frame for presentation or display in accordance with the display order hint value for the sixth reconstructed frame, such as by including the sixth reconstructed frame in the reconstructed video data at a sequentially fourth position, such as shown (at 830) in FIG. 8.

Subsequent to coding the sixth frame coded (coding order 5) the current display order hint value is three (3), the reference frame buffer includes the first reconstructed frame including the display order hint value zero (0), the second reconstructed frame including the display order hint value eight (8), the third reconstructed frame including the display order hint value four (4), the fourth reconstructed frame including the display order hint value two (2), the fifth reconstructed frame including the display order hint value one (1), and the sixth reconstructed frame including the display order hint value three (3), and the reconstructed video data includes the first reconstructed frame at the sequentially first location, followed by the fifth reconstructed frame at the sequentially second location, followed by the fourth reconstructed frame at the sequentially third position, followed by the sixth reconstructed frame at the sequentially fourth location.

Subsequent to coding the sixth frame coded (coding order 5), the encoder includes, in the encoded bitstream, a second show-existing-frame frame header including a flag, bit, or symbol, (show_existing_frame=1) indicating that the third reconstructed frame including the display order hint value four (4), previously buffered in the reference frame buffer, is to be displayed in accordance with decoding the second show-existing-frame frame header.

Subsequent to coding the sixth frame coded (coding order 5), the decoder receives, reads, obtains, or otherwise accesses, the second show-existing-frame frame header from the encoded bitstream, and, in response, outputs the third reconstructed frame for presentation or display, such as by including the third reconstructed frame in the reconstructed video data at a sequentially fifth position.

In the example shown in FIG. 11, a seventh frame in input order (frame 6) is the seventh frame coded (coding order 6), coded with a show frame value of zero (0), and has the seventh target display order (display order 6) as shown at 1170.

Prior to coding the seventh frame coded (coding order 6) the current display order hint value is three (3), the reference frame buffer includes the first reconstructed frame including the display order hint value zero (0), the second reconstructed frame including the display order hint value eight (8), the third reconstructed frame including the display order hint value four (4), the fourth reconstructed frame including the display order hint value two (2), the fifth reconstructed frame including the display order hint value one (1), and the sixth reconstructed frame including the display order hint value three (3), and the reconstructed video data includes the first reconstructed frame at the sequentially first location, followed by the fifth reconstructed frame at the sequentially second location, followed by the fourth reconstructed frame at the sequentially third position, followed by the sixth reconstructed frame at the sequentially fourth location, followed by the third reconstructed frame at the sequentially fifth location.

Encoding the seventh frame coded (coding order 6), coded with a show frame value of zero (0), includes signaling an order hint value of six (6), such as shown (at 770) in FIG. 7.

Decoding the seventh frame coded (coding order 6), coded with a show frame value of zero (0), includes decoding the order hint value of six (6), from the encoded bitstream, such as from a header for the third frame coded, such as shown (at 1030) in FIG. 10.

Decoding the seventh frame coded (coding order 6), coded with a show frame value of zero (0), omits incrementing the current display order hint value.

Decoding the seventh frame coded (coding order 6), coded with a show frame value of zero (0), includes obtaining a display order hint value for the seventh frame coded (coding order 6) in accordance with the order hint value of six (6) and at least one display order hint value from the previously reconstructed frame data from the reference frame buffer, such as shown (at 1040) in FIG. 10.

Decoding the seventh frame coded (coding order 6), coded with a show frame value of zero (0), includes storing a seventh reconstructed frame, generated by decoding the seventh frame coded (coding order 6), in the reference frame buffer, which includes storing the display order hint value six (6) as the display order hint value for the seventh reconstructed frame, such as shown (at 830) in FIG. 8.

Subsequent to coding the seventh frame coded (coding order 6) the current display order hint value is three (3), the reference frame buffer includes the first reconstructed frame including the display order hint value zero (0), the second reconstructed frame including the display order hint value eight (8), the third reconstructed frame including the display order hint value four (4), the fourth reconstructed frame including the display order hint value two (2), the fifth reconstructed frame including the display order hint value one (1), the sixth reconstructed frame including the display order hint value three (3), and the seventh reconstructed frame including the display order hint value six (6), and the reconstructed video data includes the first reconstructed frame at the sequentially first location, followed by the fifth reconstructed frame at the sequentially second location, followed by the fourth reconstructed frame at the sequentially third position, followed by the sixth reconstructed frame at the sequentially fourth location, followed by the third reconstructed frame at the sequentially fifth location.

In the example shown in FIG. 11, a sixth frame in input order (frame 5) is the eighth frame coded (coding order 7), coded with a show frame value of one (1), and has the sixth target display order (display order 5) as shown at 1160.

Prior to coding the eighth frame coded (coding order 7) the current display order hint value is three (3), the reference frame buffer includes the first reconstructed frame including the display order hint value zero (0), the second reconstructed frame including the display order hint value eight (8), the third reconstructed frame including the display order hint value four (4), the fourth reconstructed frame including the display order hint value two (2), the fifth reconstructed frame including the display order hint value one (1), the sixth reconstructed frame including the display order hint value three (3), and the seventh reconstructed frame including the display order hint value six (6), and the reconstructed video data includes the first reconstructed frame at the sequentially first location, followed by the fifth reconstructed frame at the sequentially second location, followed by the fourth reconstructed frame at the sequentially third position, followed by the sixth reconstructed frame at the sequentially fourth location, followed by the third reconstructed frame at the sequentially fifth location.

Encoding the eighth frame coded (coding order 7), coded with a show frame value of one (1), omits signaling an order hint value for the eighth frame coded or a display order hint value for the eighth frame coded.

Decoding the eighth frame coded (coding order 7), coded with a show frame value of one (1), omits decoding an order hint value for the eighth frame coded or a display order hint value for the eighth frame coded.

Decoding the eighth frame coded (coding order 7), coded with a show frame value of one (1), includes incrementing the current display order hint value, from three (3) to four (4), such as shown (at 930) in FIG. 9.

Decoding the eighth frame coded (coding order 7), coded with a show frame value of one (1), includes determining that the third reconstructed frame including the display order hint value four (4) that matches the current display order hint value is available from the reference frame buffer, such as shown (at 940) in FIG. 9.

Decoding the eighth frame coded (coding order 7), coded with a show frame value of one (1), includes second incrementing the current display order hint value, from four (4) to five (5), such as shown (at 950) in FIG. 9.

Decoding the eighth frame coded (coding order 7), coded with a show frame value of one (1), includes storing an eighth reconstructed frame, generated by decoding the eighth frame coded (coding order 7), in the reference frame buffer, which includes storing the current display order hint value, five (5), as the display order hint value for the eighth reconstructed frame, such as shown (at 830) in FIG. 8.

Decoding the eighth frame coded (coding order 7), coded with a show frame value of one (1), includes outputting the eighth reconstructed frame for presentation or display in accordance with the display order hint value for the eighth reconstructed frame, such as by including the eighth reconstructed frame in the reconstructed video data at a sequentially sixth position, such as shown (at 830) in FIG. 8.

Subsequent to coding the eighth frame coded (coding order 7) the current display order hint value is five (5), the reference frame buffer includes the first reconstructed frame including the display order hint value zero (0), the second reconstructed frame including the display order hint value eight (8), the third reconstructed frame including the display order hint value four (4), the fourth reconstructed frame including the display order hint value two (2), the fifth reconstructed frame including the display order hint value one (1), the sixth reconstructed frame including the display order hint value three (3), the seventh reconstructed frame including the display order hint value six (6), and the eighth reconstructed frame including the display order hint value three (3), and the reconstructed video data includes the first reconstructed frame at the sequentially first location, followed by the fifth reconstructed frame at the sequentially second location, followed by the fourth reconstructed frame at the sequentially third position, followed by the sixth reconstructed frame at the sequentially fourth location, followed by the third reconstructed frame at the sequentially fifth location, followed by the eighth reconstructed frame at the sequentially sixth location.

Subsequent to coding the eighth frame coded (coding order 7), the encoder includes, in the encoded bitstream, a third show-existing-frame frame header including a flag, bit, or symbol, (show_existing_frame=1) indicating that the seventh reconstructed frame including the display order hint value six (6), previously buffered in the reference frame buffer, is to be displayed in accordance with decoding the third show-existing-frame frame header.

Subsequent to coding the eighth frame coded (coding order 7), the decoder receives, reads, obtains, or otherwise accesses, the third show-existing-frame frame header from the encoded bitstream, and, in response, obtains the seventh reconstructed frame from the reference frame buffer and outputs the seventh reconstructed frame for presentation or display, such as by including the seventh reconstructed frame in the reconstructed video data at a sequentially seventh position.

In the example shown in FIG. 11, an eighth frame in input order (frame 7) is the ninth frame coded (coding order 8), coded with a show frame value of one (1), and has the eighth target display order (display order 7) as shown at 1180.

Prior to coding the ninth frame coded (coding order 8) the current display order hint value is five (5), the reference frame buffer includes the first reconstructed frame including the display order hint value zero (0), the second reconstructed frame including the display order hint value eight (8), the third reconstructed frame including the display order hint value four (4), the fourth reconstructed frame including the display order hint value two (2), the fifth reconstructed frame including the display order hint value one (1), the sixth reconstructed frame including the display order hint value three (3), the seventh reconstructed frame including the display order hint value six (6), and the eighth reconstructed frame including the display order hint value three (3), and the reconstructed video data includes the first reconstructed frame at the sequentially first location, followed by the fifth reconstructed frame at the sequentially second location, followed by the fourth reconstructed frame at the sequentially third position, followed by the sixth reconstructed frame at the sequentially fourth location, followed by the third reconstructed frame at the sequentially fifth location, followed by the eighth reconstructed frame at the sequentially sixth location, followed by the seventh reconstructed frame at the sequentially seventh location.

Encoding the ninth frame coded (coding order 8), coded with a show frame value of one (1), omits signaling an order hint value for the ninth frame coded or a display order hint value for the ninth frame coded.

Decoding the ninth frame coded (coding order 8), coded with a show frame value of one (1), omits decoding an order hint value for the ninth frame coded or a display order hint value for the ninth frame coded.

Decoding the ninth frame coded (coding order 8), coded with a show frame value of one (1), includes incrementing the current display order hint value, from five (5) to six (6), such as shown (at 930) in FIG. 9.

Decoding the ninth frame coded (coding order 8), coded with a show frame value of one (1), includes determining that the seventh reconstructed frame including the display order hint value six (6) that matches the current display order hint value is available from the reference frame buffer, such as shown (at 940) in FIG. 9.

Decoding the ninth frame coded (coding order 8), coded with a show frame value of one (1), includes second incrementing the current display order hint value, from six (6) to seven (7), such as shown (at 950) in FIG. 9.

Decoding the ninth frame coded (coding order 8), coded with a show frame value of one (1), includes storing a ninth reconstructed frame, generated by decoding the ninth frame coded (coding order 8), in the reference frame buffer, which includes storing current display order hint value, seven (7), as the display order hint value for the ninth reconstructed frame, such as shown (at 830) in FIG. 8.

Decoding the ninth frame coded (coding order 8), coded with a show frame value of one (1), includes outputting the ninth reconstructed frame for presentation or display in accordance with the display order hint value for the ninth reconstructed frame, such as by including the ninth reconstructed frame in the reconstructed video data at a sequentially eighth position, such as shown (at 830) in FIG. 8.

Subsequent to coding the ninth frame coded (coding order 8) the current display order hint value is seven (7), the reference frame buffer includes the first reconstructed frame including the display order hint value zero (0), the second reconstructed frame including the display order hint value eight (8), the third reconstructed frame including the display order hint value four (4), the fourth reconstructed frame including the display order hint value two (2), the fifth reconstructed frame including the display order hint value one (1), the sixth reconstructed frame including the display order hint value three (3), the seventh reconstructed frame including the display order hint value six (6), the eighth reconstructed frame including the display order hint value three (3), and the ninth reconstructed frame including the display order hint value seven (7), and the reconstructed video data includes the first reconstructed frame at the sequentially first location, followed by the fifth reconstructed frame at the sequentially second location, followed by the fourth reconstructed frame at the sequentially third position, followed by the sixth reconstructed frame at the sequentially fourth location, followed by the third reconstructed frame at the sequentially fifth location, followed by the eighth reconstructed frame at the sequentially sixth location, followed by the seventh reconstructed frame at the sequentially seventh location, followed by the ninth reconstructed frame at the sequentially eighth location.

Subsequent to coding the ninth frame coded (coding order 8), the encoder includes, in the encoded bitstream, a fourth show-existing-frame frame header including a flag, bit, or symbol, (show_existing_frame=1) indicating that the second reconstructed frame including the display order hint value eight (8), previously buffered in the reference frame buffer, is to be displayed in accordance with decoding the fourth show-existing-frame frame header.

Subsequent to coding the ninth frame coded (coding order 8), the decoder receives, reads, obtains, or otherwise accesses, the fourth show-existing-frame frame header from the encoded bitstream, and, in response, obtains the second reconstructed frame from the reference frame buffer and outputs the second reconstructed frame for presentation or display, such as by including the second reconstructed frame in the reconstructed video data at a sequentially ninth position.

As used herein, the terms “optimal”, “optimized”, “optimization”, or other forms thereof, are relative to a respective context and are not indicative of absolute theoretic optimization unless expressly specified herein.

As used herein, the term “set” indicates a distinguishable collection or grouping of zero or more distinct elements or members that may be represented as a one-dimensional array or vector, except as expressly described herein or otherwise clear from context.

The words “example” or “exemplary” are used herein to mean serving as an example, instance, or illustration. Any aspect or design described herein as “example” or “exemplary” not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. As used herein, the terms “determine” and “identify”, or any variations thereof, includes selecting, ascertaining, computing, looking up, receiving, determining, establishing, obtaining, or otherwise identifying or determining in any manner whatsoever using one or more of the devices shown in FIG. 1.

Further, for simplicity of explanation, although the figures and descriptions herein may include sequences or series of steps or stages, elements of the methods disclosed herein can occur in various orders and/or concurrently. Additionally, elements of the methods disclosed herein may occur with other elements not explicitly presented and described herein. Furthermore, one or more elements of the methods described herein may be omitted from implementations of methods in accordance with the disclosed subject matter.

The implementations of the transmitting computing and communication device 100A and/or the receiving computing and communication device 100B (and the algorithms, methods, instructions, etc. stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting computing and communication device 100A and the receiving computing and communication device 100B do not necessarily have to be implemented in the same manner.

Further, in one implementation, for example, the transmitting computing and communication device 100A or the receiving computing and communication device 100B can be implemented using a computer program that, when executed, carries out any of the respective methods, algorithms and/or instructions described herein. In addition, or alternatively, for example, a special purpose computer/processor can be utilized which can contain specialized hardware for carrying out any of the methods, algorithms, or instructions described herein.

The transmitting computing and communication device 100A and receiving computing and communication device 100B can, for example, be implemented on computers in a real-time video system. Alternatively, the transmitting computing and communication device 100A can be implemented on a server and the receiving computing and communication device 100B can be implemented on a device separate from the server, such as a hand-held communications device. In this instance, the transmitting computing and communication device 100A can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting computing and communication device 100A. Other suitable transmitting computing and communication device 100A and receiving computing and communication device 100B implementation schemes are available. For example, the receiving computing and communication device 100B can be a generally stationary personal computer rather than a portable communications device and/or a device including an encoder 400 may also include a decoder 500.

Further, all or a portion of implementations can take the form of a computer program product accessible from, for example, a tangible computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

It will be appreciated that aspects can be implemented in any convenient form. For example, aspects may be implemented by appropriate computer programs which may be carried on appropriate carrier media which may be tangible carrier media (e.g., disks) or intangible carrier media (e.g. communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

The above-described implementations have been described in order to allow easy understanding of the application are not limiting. On the contrary, the application covers various modifications and equivalent arrangements included within the scope of the appended claims, which scope is to be accorded the broadest interpretation so as to encompass all such modifications and equivalent structure as is permitted under the law.

1. A method comprising:
generating reconstructed video data by decoding an encoded bitstream, wherein decoding the encoded bitstream includes obtaining reconstructed frame data for a current frame of a sequence of frames, wherein obtaining the reconstructed frame data includes:
accessing, from the encoded bitstream, a show frame value from a frame header for the current frame;
obtaining a current display order hint value, wherein obtaining the current display order hint value includes, in response to determining that the show frame value is a first defined show frame value, incrementing the current display order hint value;
obtaining a display order hint value for the current frame, wherein obtaining the display order hint value for the current frame includes, in response to determining that the show frame value is the first defined show frame value, obtaining, as the display order hint value for the current frame, the current display order hint value, wherein an order hint value for the current frame is absent from the encoded bitstream; and
including the reconstructed frame data in the reconstructed video data in accordance with the display order hint value for the current frame; and
outputting the reconstructed video data.

2. The method of claim 1, wherein:
obtaining the current display order hint value includes determining whether the show frame value is the first defined show frame value.

3. The method of claim 1, wherein prior to obtaining the current display order hint value, the current display order hint value is a defined initiation value.

4. The method of claim 1, wherein prior to obtaining the current display order hint value, the current display order hint value is a previously obtained current display order hint value previously obtained in accordance with obtaining previously reconstructed frame data.

5. The method of claim 1, wherein incrementing the current display order hint value includes:
first incrementing the current display order hint value; and
in response to determining that a reference frame buffer includes previously reconstructed frame data that includes a previously reconstructed display order hint value that matches the current display order hint value, second incrementing the current display order hint value.

6. The method of claim 5, wherein incrementing the current display order hint value includes:
determining whether the reference frame buffer includes the previously reconstructed frame data that includes the previously reconstructed display order hint value that matches the current display order hint value.

7. The method of claim 1, wherein:
a reference frame buffer includes previously reconstructed frame data for a plurality of previously reconstructed frames; and
determining that the reference frame buffer includes the previously reconstructed frame data that includes a previously reconstructed display order hint value that matches the current display order hint value includes determining whether the previously reconstructed frame data includes the previously reconstructed display order hint value that matches the current display order hint value iteratively on a per-previously reconstructed frame basis.

8. The method of claim 1, wherein obtaining the display order hint value for the current frame includes determining whether the show frame value is the first defined show frame value.

9. The method of claim 1, wherein obtaining the reconstructed frame data includes:
prior to accessing the show frame value, accessing, from the encoded bitstream, a syntax element indicating that the order hint value may be absent from the encoded bitstream.

10. The method of claim 1, wherein decoding the encoded bitstream includes obtaining second reconstructed frame data for a second frame of the sequence of frames, wherein obtaining the second reconstructed frame data includes:
accessing, from the encoded bitstream, a second show frame value from a second frame header for the second frame;
obtaining the current display order hint value, wherein obtaining the current display order hint value includes, in response to determining that the second show frame value is other than the first defined show frame value, omitting incrementing the current display order hint value;
obtaining a second display order hint value for the second frame, wherein obtaining the second display order hint value for the second frame includes, in response to determining that the second show frame value is other than the first defined show frame value:
accessing, from the second frame header, a second order hint value for the second frame; and
determining the second display order hint value for the second frame in accordance with the second order hint value and at least one display order hint value from previously reconstructed frame data; and
including the second reconstructed frame data in the reconstructed video data in accordance with the second display order hint value for the second frame.

11. A non-transitory computer-readable storage medium having stored thereon an encoded bitstream comprising:
a first frame header for a first frame of a sequence of frames, wherein:
the first frame header includes a first show frame value for the first frame that has a first defined show frame value; and
an order hint value for the first frame is absent from the encoded bitstream; and
a second frame header for a second frame of the sequence of frames, wherein the second frame header includes:
a second show frame value for the second frame that has a second defined show frame value; and
a second order hint value for the second frame.

12. The non-transitory computer-readable storage medium of claim 11, wherein the encoded bitstream includes a syntax element indicating that one or more order hint values may be absent from the encoded bitstream.

13. The non-transitory computer-readable storage medium of claim 11, wherein:
the first show frame value corresponds with decoding a first portion of the encoded bitstream to reconstruct the first frame by:
incrementing a current display order hint value; and
obtaining, as a first display order hint value for the first frame, the current display order hint value; and
the second show frame value corresponds with decoding a second portion of the encoded bitstream to reconstruct the second frame by:
omitting incrementing the current display order hint value;
accessing the second order hint value for the second frame; and
determining a second display order hint value for the second frame in accordance with the second order hint value and at least one display order hint value from previously reconstructed frame data.

14. An apparatus comprising:
a non-transitory computer-readable medium; and
a processor configured to execute instructions stored on the non-transitory computer-readable medium to:
generate reconstructed video data, wherein, to generate the reconstructed video data the processor is configured to execute the instructions to decode an encoded bitstream, wherein to decode the encoded bitstream the processor is configured to execute the instructions to obtain reconstructed frame data for a current frame of a sequence of frames, wherein to obtain the reconstructed frame data the processor is configured to execute the instructions to:
access, from the encoded bitstream, a show frame value from a frame header for the current frame;
obtain a current display order hint value, wherein to obtain the current display order hint value the processor is configured to execute the instructions to in response to a determination that the show frame value is a first defined show frame value, increment the current display order hint value;
obtain a display order hint value for the current frame, wherein to obtain the display order hint value for the current frame the processor is configured to execute the instructions to, in response to a determination that the show frame value is the first defined show frame value, obtain, as the display order hint value for the current frame, the current display order hint value, wherein an order hint value for the current frame is absent from the encoded bitstream; and
include the reconstructed frame data in the reconstructed video data in accordance with the display order hint value for the current frame; and
output the reconstructed video data.

15. The apparatus of claim 14, wherein:
to obtain the current display order hint value the processor is configured to execute the instructions to determine whether the show frame value is the first defined show frame value.

16. The apparatus of claim 14, wherein to increment the current display order hint value the processor is configured to execute the instructions to:
perform a first increment of the current display order hint value; and
in response to a determination that a reference frame buffer includes previously reconstructed frame data that includes a previously reconstructed display order hint value that matches the current display order hint value, perform a second increment the current display order hint value.

17. The apparatus of claim 14, wherein:
a reference frame buffer includes previously reconstructed frame data for a plurality of previously reconstructed frames; and
to determine that the reference frame buffer includes the previously reconstructed frame data that includes a previously reconstructed display order hint value that matches the current display order hint value the processor is configured to execute the instructions to determine whether the previously reconstructed frame data includes the previously reconstructed display order hint value that matches the current display order hint value iteratively on a per-previously reconstructed frame basis.

18. The apparatus of claim 14, wherein to obtain the display order hint value for the current frame the processor is configured to execute the instructions to determine whether the show frame value is the first defined show frame value.

19. The apparatus of claim 14, wherein to obtain the reconstructed frame data the processor is configured to execute the instructions to:
prior to accessing the show frame value, access, from the encoded bitstream, a syntax element indicating that the order hint value may be absent from the encoded bitstream.

20. The apparatus of claim 14, wherein, to decode the encoded bitstream, the processor is configured to execute the instructions to obtain second reconstructed frame data for a second frame of the sequence of frames, wherein to obtain the second reconstructed frame data the processor is configured to execute the instructions to:
access, from the encoded bitstream, a second show frame value from a second frame header for the second frame;
obtain the current display order hint value, wherein to obtain the current display order hint value the processor is configured to execute the instructions to, in response to a determination that the second show frame value is other than the first defined show frame value, omit incrementing the current display order hint value;
obtain a second display order hint value for the second frame, wherein to obtain the second display order hint value for the second frame the processor is configured to execute the instructions to, in response to a determination that the second show frame value is other than the first defined show frame value:
access, from the second frame header, a second order hint value for the second frame; and
determine the second display order hint value for the second frame in accordance with the second order hint value and at least one display order hint value from previously reconstructed frame data; and
include the second reconstructed frame data in the reconstructed video data in accordance with the second display order hint value for the second frame.
